(19) United States
(12) Patent Application Publication
(10) Pub. No.: US 2005/0088535 A1
(43) Pub. Date: Apr. 28, 2005

(54) Solid state image pickup device

(75) Inventor: Toshinobu Hatano, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/970,988

(22) Filed: Oct. 25, 2004

(30) Foreign Application Priority Data
Oct. 27, 2003 (JP) P2003-366149

(51) Int. Cl. H04N 5/225

(52) U.S. Cl. 348/220.1

(57) ABSTRACT

A solid state image pickup device of the present invention comprises a photoelectrical conversion element array and a pixel-data-reading-out control unit. The pixel-data-reading-out control unit has a still-picture-reading-out mode and moving-picture-reading-out mode for pixel data read out from the photoelectrical conversion element array. In the moving-picture-reading-out mode, interlace reading-out is performed on a plurality of adjacent pixel data as a group on the whole screen obtained on the photoelectrical conversion element array. Thereby, the speed of reading out the pixel data can be increased and the quality of recorded moving pictures can be improved.

### BACKGROUND OF THE INVENTION

1. Field of the Invention

The present invention relates to a solid state image pickup device comprising reading-out mode for picking up still pictures and reading-out mode for recording moving pictures for pixel data which are read out from a photoelectrical conversion element array.

2. Description of the Related Art

As for the photoelectrical conversion element arrays of solid state image pickup devices, a remarkable increase in the number of pixels has been achieved due to the recent development in semiconductor technology. A sufficiently large numbers of pixels are referred to as being high pixels. For picking up still pictures, it is carried out by utilizing the pixel data for the whole pixels on the photoelectrical conversion element array. This is called a whole-pixel-reading-out mode, in which the pixel data of the whole pixels read out from the photoelectrical conversion element array are outputted in order by a single pixel unit. Thereby, it enables to achieve highly fine still pictures.

In the meantime, there are solid state image pickup devices which are configured to be capable of switching two modes for picking up still pictures and for recording moving pictures. At present, there is a specific limit in an operation speed of digital signal processing circuits such as DSP and the like. Further, in terms of power consumption, it is difficult to record moving pictures by the same whole-pixel-reading-out mode as the one used for picking up still pictures. For recording moving pictures, it is common to perform pixel-data processing by increasing the number of frames per unit time through thinning out the pixels after mixing the pixels. This is called a mixed-pixel-reading-out mode.

For the pixel data read out from the photoelectrical conversion element array, after mixing a plurality of pixels at least in the vertical direction of the array, the mixed pixel data is outputted as the pixel data of one unit. Thereby, the number of frames per unit time is increased so that it enables to achieve a smooth and fast moving-picture recording also by a solid state image pickup device to which a photoelectrical conversion element array with high pixels is mounted.

Switching of the pixel-thinning-out/mixed-pixel-reading-out mode and whole-pixel-reading-out mode as described above can be excellently achieved especially by MOS (Metal Oxide Semiconductor) image sensors. The reason is that the MOS sensors, unlike CCD (Charge Coupled Device) image sensors, do not require transfer of electric charges by shift of potential well and are capable of freely reading out pixel data in arbitrary lines by utilizing signal lines (wires). The MOS image sensor is advantageous in respect that it can be operated with low voltage, bears less amount of current leak, has still larger numerical aperture compared to the CCD in the same size, has high sensitivity, can read out data easily compared to the CCD, etc. Especially, it is extremely advantageous in respect that it can select and read out pixels at will, and in terms of mixing the pixels.

As for scanning performed on the whole screen of the photoelectrical conversion element array, in the field of CCD image sensors, there are ones formed with progressing reading-out and ones with interlace reading-out. However, in the field of MOS image sensors, it is formed only with the progressing reading-out but does not correspond to the interlace reading-out. Therefore, recording of high-vision moving pictures or, equivalently, recording of moving pictures with high pixels and high qualities has not been achieved.

### BRIEF DESCRIPTION OF THE INVENTION

The present invention enables, in a solid state image pickup device formed to be capable of switching two modes for picking up highly fine still pictures with high pixels and for recording highly fine moving pictures with smooth movements, a high-speed reading-out of pixel-data by employing interlace reading-out so as to achieve recording of moving pictures with high quality.

The solid state image pickup device of the present invention comprising:
a photoelectrical conversion element array in matrix form for performing photoelectrical conversion on an optical image entered through an optical system so as to convert it into an electric signal; and
a pixel-data-reading-out control unit having a still-picture-reading-out mode and a moving-picture-reading-out mode for pixel data which is read out from said photoelectrical conversion element array, said pixel-data-reading-out control unit performing interlace reading-out in said moving-picture-reading-out mode by reading out a plurality of adjacent lines as a group of pixel data on whole screen obtained on said photoelectrical conversion element array.

As the pixel-data-reading-out control unit, there are some forms as described below.

(1) The pixel-data-reading-out control unit according to a first aspect, with n being any natural number, alternately switches:
a first field scanning for performing scanning by a first scanning unit (simply referred to as a first unit hereinafter), with pixel data of adjacent 2n lines being a unit on the whole screen obtained on the photoelectrical conversion element array, by shifting 2n lines each; and
a second field scanning for performing scanning by a second scanning unit (simply referred to as a second unit hereinafter), with adjacent 2n lines which are shifted by n line from the first scanning unit of the first field scanning being a unit, by shifting 2n lines each.

At this time, the first field may be an odd-number field and the second field may be an even-number field. Inversely, the first field may be the even-number field and the second field may be the odd-number field.

In the above-described form, for example, scanning is performed as follows when n=1. The unit is a pair of two adjacent lines.

In the first field scanning, after performing scanning on (1st line, 2nd line) as a pair of the first unit, performed is scanning on (3rd line, 4th line) as a pair of the first unit being shifted by two lines each. Subsequently, performed is scanning on (5th line, 6th line) as a pair of the first unit being shifted by two lines each.

In the second field scanning, after performing scanning on (2nd line, 3rd line) as a pair of the second unit, which is the adjacent two lines being shifted by one line from the first unit of the first field scanning, performed is scanning on (4th line, 5th line) as a pair of the second unit being shifted by two lines each. Subsequently, performed is scanning on (6th line, 7th line) as a pair of the second unit being shifted by two lines each. In short, in the first field scanning, scanning is performed as in (1, 2), (3, 4), (5, 6) - - - (2n−1, 2n) - - - , and in the second field scanning, it is performed as in (2, 3), (4, 5), (6, 7) - - - (2n, 2n+1) - - - .

Except the 1st line, each line is commonly used in the first field scanning and the second field scanning.

Further, for example, scanning is performed as follows when n=2. The unit is a group of four adjacent lines.

In the first filed scanning, after performing scanning on (1st line, 2nd line, 3rd line, 4th line) as a group of the first unit, performed is scanning on (5th line, 6th line, 7th line, 8th line) as a group of the first unit being shifted by four lines each. Subsequently, performed is a scanning on (9th line, 10th line, 11th line, 12th line) as a group of the first unit being shifted by four lines each.

In the second field scanning, after performing scanning on (3rd line, 4th line, 5th line, 6th line) as a group of the second unit, which is the adjacent four lines being shifted by two lines from the first unit of the first field scanning, performed is scanning on (7th line, 8th line, 9th line, 10th line) as a group of the second unit being shifted by four lines each. Subsequently, performed is scanning on (11th line, 12th line, 13th line, 14th line) as a group of the second unit being shifted by four lines each. In short, in the first field scanning, scanning is performed as in (1, 2, 3, 4), (5, 6, 7, 8), (9, 10, 11, 12) - - - (4n−3, 4n−2, 4n−1, 4n) - - - , and in the second field scanning, it is performed as in (3, 4, 5, 6), (7, 8, 9, 10), (11, 12, 13, 14) - - - (4n−1, 4n, 4n+1, 4n+2) - - - .

Except the 1st line and 2nd line, each line is commonly used in the first field scanning and the second field scanning.

With the present invention, it enables to record high-vision moving pictures or, equivalently, moving pictures with high pixels and high qualities by employing the interlace reading-out.

(2) The pixel-data-reading-out control unit according to a second aspect comprises:
a whole-pixel-reading-out mode for picking up still pictures which outputs pixel data read out from the photoelectrical conversion element array in order by each pixel; and mixed-pixel-reading-out mode for recording moving pictures which outputs pixel data by mixing the data of a plurality of pixels in at least vertical direction of the array, wherein
the pixel-data-reading-out control unit alternately switches, with n being any natural number,
a first field scanning for mixing pixel data of 2n+1 lines by skipping one line through performing scanning by a first scanning unit, with pixel data of adjacent 2n+1 lines being a unit on the whole screen obtained on the photoelectrical conversion element array, by shifting 2n+1 lines each; and
a second field scanning for mixing pixel data of 2n+1 lines by skipping one line through performing scanning by a second scanning unit, with adjacent 2n+1 lines which are shifted by two lines from the first scanning unit of the first field scanning being a unit, by shifting 2n+1 lines each.

At this time, the first field may be an odd-number field and the second field may be an even-number field. Inversely, the first field may be the even-number field and the second field may be the odd-number field.

In the above-described form, for example, scanning is performed as follows when n=1. The unit is a group of three adjacent lines.

In the first field scanning, after mixing three vertical pixels by skipping one line (1st line, 3rd line, 5th line) as a group of the first unit, performed is mixing of three vertical pixels by skipping one line on (4th line, 6th line, 8th line) as a group of the first unit being shifted by three lines each. Subsequently, performed is mixing of three vertical pixels by skipping one line on (7th line, 9th line, 11th line) as a group of the first unit being shifted by three lines each. Further, performed is mixing of three vertical pixels by skipping one line on (10th line, 12th line, 14th line) as a group of the first unit being shifted by three lines each.

In the second field scanning, after mixing three vertical pixels by skipping one line (3rd line, 5th line, 7th line) as a group of the second unit, which is the adjacent three lines being shifted by two line from the first unit of the first field scanning, performed is mixing of three vertical pixels by skipping one line on (6th line, 8th line, 10th line) as a group of the second unit being shifted by three lines each. Subsequently, performed is mixing of three vertical pixels by skipping one line on (9th line, 11th line, 13th line) as a group of the second unit being shifted by three lines each. Further, performed is mixing of three vertical pixels by skipping one line on (12th line, 14th line, 16th line) as a group of the second unit being shifted by three lines each.

In the first field scanning, mixing of three vertical pixels is performed as in {1, 3, 5}, {4, 6, 8}, {7, 9, 11}, {10, 12, 14} - - - {2n−1, 2n+1, 2n+3}, {2n+2, 2n+4, 2n+6} - - - , and in the second field scanning, it is performed as in {3, 5, 7}, {6, 8, 10}, {9, 11, 13}, {12, 14, 16} - - - {2n+1, 2n+3, 2n+5}, {2n+4, 2n+6, 2n+8} - - - .

In the first field scanning and the second field scanning, scanning is started from the combination of the odd-number lines, and is repeated alternately on the combination of the odd-number lines and that of the even-number lines.

Except the 1st line, 2nd line and 4th line, each line is commonly used in the first field scanning and the second field scanning.

Further, for example, scanning is performed as follows when n=2. The unit is a group of five adjacent lines.

In the first field scanning, after mixing five vertical pixels by skipping one line (1st line, 3rd line, 5th line, 7th line, 9th line) as a group of the first unit, performed is mixing of five vertical pixels by skipping one line on (6thth line, 8th line, 10th line, 12th line, 14th line) as a group of the first unit being shifted by five lines each. Subsequently, performed is mixing of five vertical pixels by skipping one line on (11th line, 13th line, 15th line, 17th line, 19th line) as a group of the first unit being shifted by five lines each. Further, performed is mixing of five vertical pixels by skipping one line on (16th line, 18th line, 20th line, 22nd line, 24th line) as a group of the first unit being shifted by five lines each.

In the second field scanning, after mixing five vertical pixels by skipping one line (3rd line, 5th line, 7th line, 9th line, 11th line) as a group of the second unit, which is the five adjacent lines being shifted by two line from the first unit of the first field scanning, performed is mixing of five vertical pixels by skipping one line on (8th line, 10th line, 12th line, 14th line, 16th line) as a group of the second unit being shifted by five lines each. Subsequently, performed is mixing of five vertical pixels by skipping one line on (13th line, 15th line, 17th line, 19th line, 21st line) as a group of the second unit being shifted by five lines each. Further, performed is mixing of three vertical pixels by skipping one line on (18th line, 20th line, 22nd line, 24th line, 26th line) as a group of the second unit being shifted by five lines each.

In the first field scanning, mixing of five vertical pixels is performed as in (1, 3, 5, 7, 9), (6, 8, 10, 12, 14), (11, 13, 15, 17, 19), (16, 18, 20, 22, 24) - - - (2n−3, 2n−1, 2n+1, 2n+3, 2n+5), (2n+2, 2n+4, 2n+6, 2n+8, 2n+10) - - - , and in the second field scanning, it is performed as in (3, 5, 7, 9, 11), (8, 10, 12, 14, 16), (13, 15, 17, 19, 21), (18, 20, 22, 24, 26) - - - (2n−1, 2n+1, 2n+3, 2n+5, 2n+7), (2n+4, 2n+6, 2n+8, 2n+10, 2n+12) - - - .

In the first field scanning and the second field scanning, scanning is started from the combination of the odd-number lines, and is repeated alternately on the combination of the odd-number lines and that of the even-number lines.

Except the 1st line, 2nd line, 4th line and 6th line, each line is commonly used in the first field scanning and the second field scanning.

With the present invention, it enables to record high-vision moving pictures or, equivalently, moving pictures with high pixels and high qualities by employing the interlace reading-out together with vertical-pixel-mixing.

(3) The pixel-data-reading-out control unit according to a third aspect comprises:
a whole-pixel-reading-out mode for picking up still pictures which outputs pixel data read out from the photoelectrical conversion element array in order by each pixel; and mixed-pixel-reading-out mode for recording moving pictures which outputs pixel data by mixing the data of a plurality of pixels in at least vertical direction of the array, wherein
the pixel-data-reading-out control unit alternately switches, with n being any natural number,
a first field scanning for mixing pixel data of two pairs of 2n lines through performing scanning by a first scanning unit, with pixel data of adjacent 4n lines being a unit on the whole screen obtained on the photoelectrical conversion element array, by shifting 4n lines each; and
a second field scanning for mixing pixel data of two pairs of 2n lines through performing scanning by a second scanning unit, with adjacent 4n lines being shifted by 2n lines from the first scanning unit of the first field scanning being a unit, by shifting 4n lines each.

At this time, the first field may be an odd-number field and the second field may be an even-number field. Inversely, the first field may be the even-number field and the second field may be the odd-number field.

In the above-described form, for example, scanning is performed as follows when n=1. The unit is a group of four adjacent lines.

In the first field scanning, after mixing two pairs of two vertical pixels (1st line, 2nd line, 3rd line, 4th line) of the first unit, performed is mixing of two pairs of two vertical pixels on (5th line, 6th line, 7th line, 8th line) as pairs of the first unit being shifted by four lines each. Subsequently, performed is mixing of two pairs of two vertical pixels on (9th line, 10th line, 11th line, 12th line) as pairs of the first unit being shifted by four lines each.

In the second field scanning, after mixing two pairs of two vertical pixels (3rd line, 4th line, 5th line, 6th line) as pairs of the second unit, which is the four adjacent lines being shifted by two lines from the first unit of the first field scanning, performed is mixing of two pairs of two vertical pixels on (7th line, 8th line, 9th line, 10th line) as pairs of the second unit being shifted by four lines each. Subsequently, performed is mixing of two pairs of two vertical pixels on (11th line, 12th line, 13th line, 14th line) as pairs of the second unit being shifted by four lines each.

In the first field scanning, mixing of two pairs of two vertical pixels is performed as in (1, 2, 3, 4), (5, 6, 7, 8), (9, 10, 11, 12) - - - (4n−3, 4n−2, 4n−1, 4n) - - - , and further, ({1, 3}), {2, 4}), ({5, 7}, {6, 8}), ({9, 11}, {10, 12}) - - - ({4n−3, 4n−1}, {4n−2, 4n}) - - - . In the second field scanning, it is performed as in (3, 4, 5, 6), (7, 8, 9, 10), (11, 12, 13, 14) - - - (4n−1, 4n, 4n+1, 4n+2) - - - , and further, ({3, 5}), {4, 6}), ({7, 9}, {8, 10}), ({11, 13}, {12, 14}) - - - ({4n−1, 4n+1}, {4n, 4n+2}) - - - .

With the present invention, since it uses the interlace reading-out together with vertical-pixel-mixing and, in addition, employs simultaneous parallel output through a plurality of channels, it enables to record high-vision moving pictures or, equivalently, moving pictures with high pixels and high qualities.

(4) In the solid state image pickup device according to a fourth aspect of the present invention, the pixel-data-reading-out control unit described in (1), (2), (3) further performs horizontal mixing pixels in each scanning unit. Therefore, the interlace reading-out is performed also with horizontal-pixel-mixing. Thus, speed of reading-out with high pixels can be further increased and it enables to record high-vision moving pictures or, equivalently, moving pictures with high pixels and high qualities.

In (1) described above, the photoelectrical conversion element array may be a monochrome type or color type. Further, in (2)-(4) which includes mixing of pixels, the photoelectrical conversion element array is set to be a color type. In the case of the color type, it has a configuration with a plurality of color filters provided on the front face. Any types of color filters may be used. For example, Bayer pattern of RGB (R is Red, G is green, B is blue), or a complementary color type of cyanogens, magenta, yellow (also green) may be used.

Specifically, the preferable configuration of the above-described pixel-data-reading-out control unit is as follows. That is, the pixel-data-reading-out control unit comprises:
a vertical transfer switch circuit for reading out pixel data from the photoelectrical conversion element array;
a signal voltage holding circuit for temporarily holding the read-out pixel-data;
a horizontal transfer switch circuit for outputting pixel data or mixed pixel data from the signal voltage holding circuit;
an output amplifier for outputting the pixel data or mixed pixel data transmitted from a horizontal transfer switch circuit; and
a horizontal shift selection circuit for switching output by the whole-pixel-reading-out mode and output by the mixed-pixel-reading-out mode through controlling the horizontal transfer switch circuit.

With this configuration, pixel data of arbitrary pixels can be read out at will and it enables to sufficiently work out the effects described above.

Additional objects and advantages of the present invention will be apparent from the following description of preferred embodiments thereof, which are best understood with reference to the accompanying drawings.

### BRIEF DESCRIPTION OF THE DRAWINGS

FIG. 1 is a block diagram showing a basic configuration of a solid state image pickup device according to a first embodiment of the present invention;

FIG. 2 is a model illustration for describing operation of a whole-pixel-reading-out mode of the solid state image pickup device according to the first embodiment of the present invention;

FIG. 3 is a model illustration for describing operation of an interlace reading-out mode of the solid state image pickup device according to the first embodiment of the present invention;

FIG. 4 is an exploded block diagram for showing, in a more specific level, the configuration of the solid state image pickup device according to the first embodiment of the present invention;

FIG. 5 is a circuit diagram showing a detailed configuration of a noise-removing/pixel selection circuit of the solid state image pickup device according to the first embodiment of the present invention;

FIG. 6 is a fragmentary enlarged circuit diagram of a photoelectrical conversion element array of the solid state image pickup device according to the first embodiment of the present invention;

FIG. 7 is a fragmentary enlarged circuit diagram of a circuit structure in the solid state image pickup device according to the first embodiment of the present invention, which is for reading out pixel data for pixels on two scanning lines by interlace reading-out;

FIG. 8 is a model illustration for describing operation of an interlace reading-out mode of the solid state image pickup device according to a second embodiment of the present invention;

FIG. 9 is a fragmentary enlarged circuit diagram of a circuit structure in the solid state image pickup device according to the second embodiment of the present invention, which is for reading out pixel data for pixels on two scanning lines by interlace reading-out;

FIG. 10 is a model illustration for describing operation of an interlace reading-out mode of the solid state image pickup device according to a third embodiment of the present invention;

FIG. 11 is a fragmentary enlarged circuit diagram of a circuit structure in the solid state image pickup device according to the third embodiment of the present invention, which is for reading out pixel data for pixels on two scanning lines by interlace reading-out;

FIG. 12A-FIG. 12E are model illustrations for describing operation of an interlace reading-out mode of the solid state image pickup device according to a fourth embodiment of the present invention; and

FIG. 13 is a model illustration for describing operation of an interlace reading-out mode of the solid state image pickup device according to the fourth embodiment of the present invention.

In each illustration, same reference numerals are applied to the same components.

### DETAILED DESCRIPTION OF THE PREFERRED EMBODIMENTS

In the followings, embodiments of the solid state image pickup device according to the present invention will be described in detail by referring to the accompanying drawings.

### First Embodiment

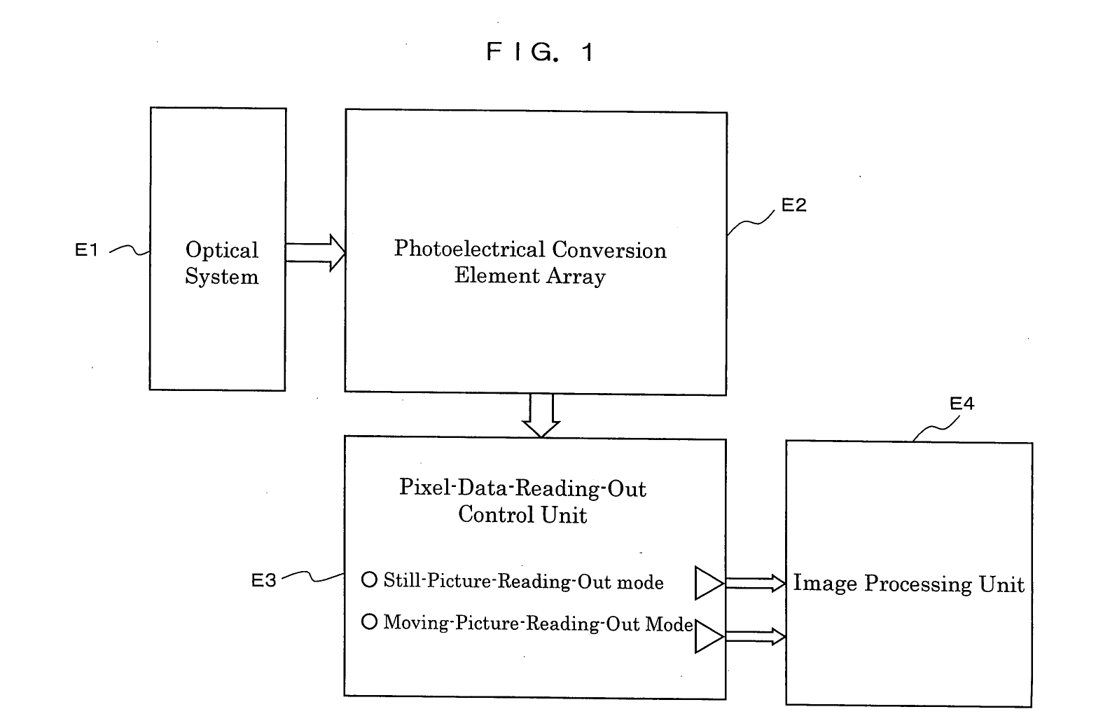

FIG. 1 is a block diagram showing the basic configuration of the solid state image pickup device according to the first embodiment of the present invention. In FIG. 1, numeral reference E1 is an optical system to which an optical image of an object makes an incidence, which comprises combination lenses made of a plurality of lenses. Numeral reference E2 is a photoelectrical conversion element array (simply referred to as an element array hereinafter) in matrix form with color filters, which converts the optical image entered through the optical system E1 to electric signals through photoelectrical conversion. Numeral reference E3 is a pixel-data-reading-out control unit, which reads out the pixel data from the element array E2 and, at the same time, outputs the read-out pixel data by switching the modes. The reading-out control unit E3 comprises a reading-out mode for picking up still pictures and a reading-out mode for recording moving pictures. In FIG. 1, numeral reference E4 is an image processing unit for performing prescribed data processing when the pixel data outputted from the reading-out control unit E3 is inputted.

In the solid state image pickup device configured as described, the optical image of the subject formed on the element array E2 through the optical system E1 is converted to electric signals by being photoelectrical-converted in the element array E2. Specifically, the reading-out control unit E3 reads out the pixel data from the element array E2. The image processing unit E4 removes reset noises and low-frequency noises of the inputted pixel data by performing CDS (Correlated Double Sampling) processing thereon. Then, AGC (Automatic Gain Control) is performed for further converting analog signals to digital data.

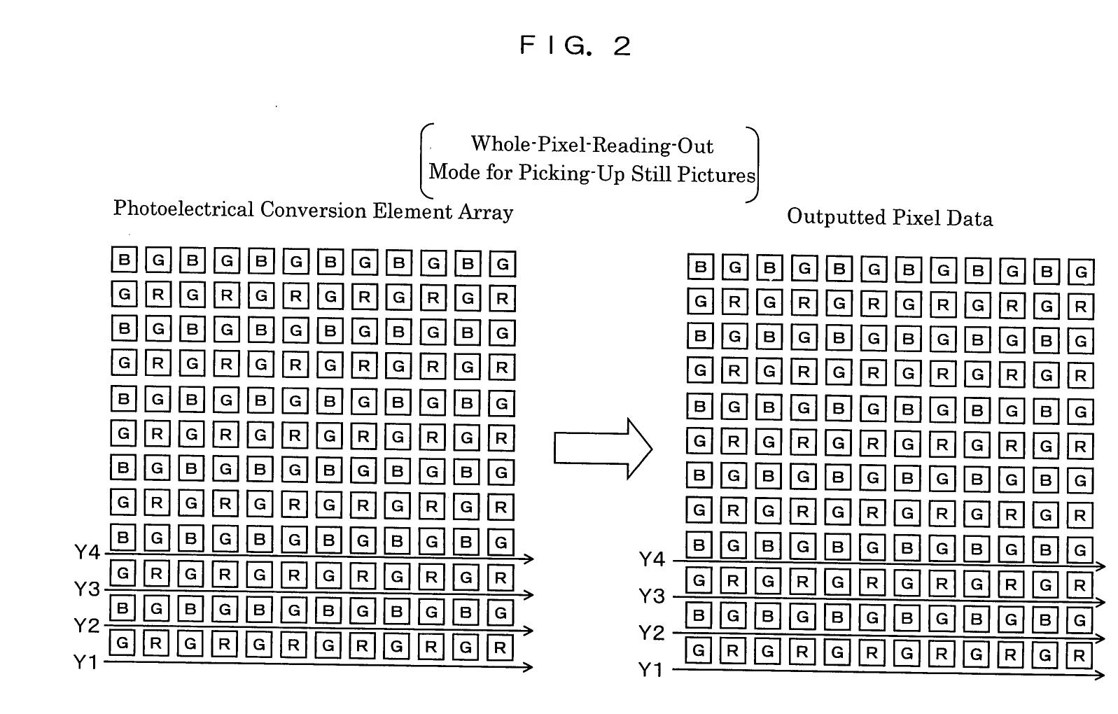

FIG. 2 is a model illustration which clearly illustrates an example of a whole-pixel-reading-out mode used at the time of picking up still pictures. In the figure, the left side shows a part of the element array E2 and the right side shows the pixel data outputted from the reading-out control unit E3. The element array E2 is in Bayer pattern in which a first G (green), R (red), B (blue) and a second G (green) are arranged. All of the pixel data for the whole pixels in the element array E2 are outputted. This mode is for picking up still pictures. Scanning is performed in order from Y1, Y2, Y3 - - - . The pixel data for the whole pixel are used so that it is to be understood that highly fine still pictures can be picked up with high pixels.

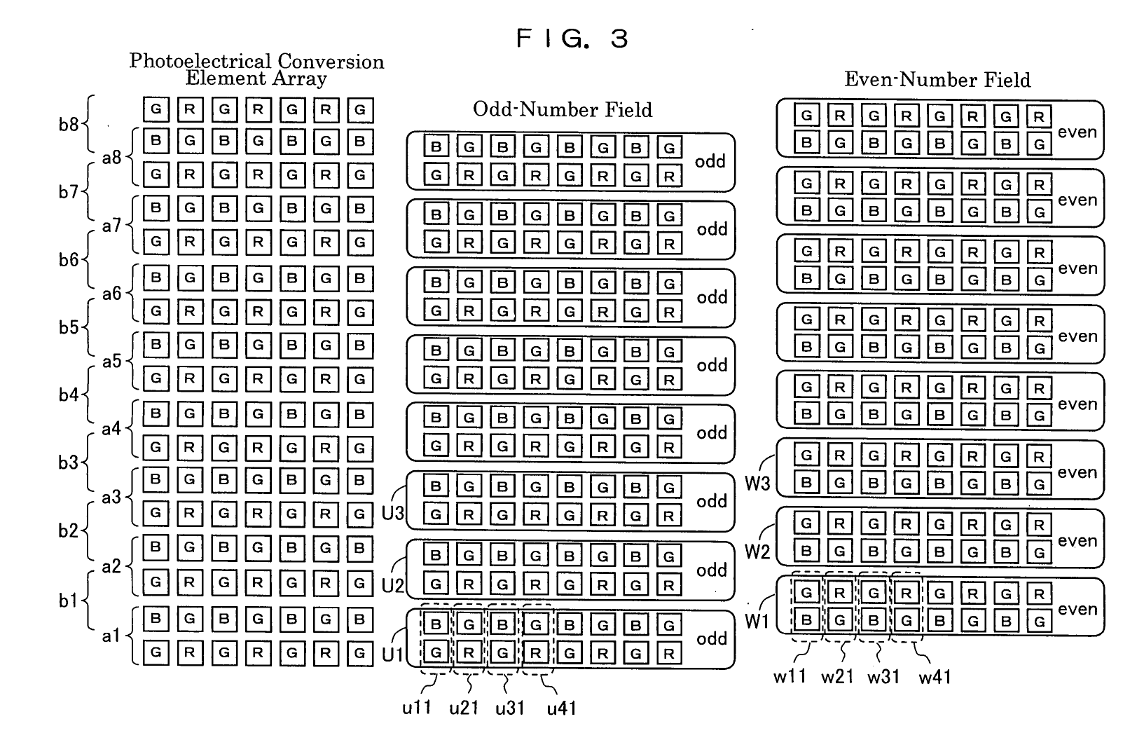

FIG. 3 is a model illustration for showing the operation of the interlace reading-out mode. The left side shows a part of the element array E2, the center shows the pixel data outputted from the reading-out control unit E3 in odd-number field, and the right side shows the pixel data outputted in even-number field.

In a first scanning unit (a first unit) a1 of the odd-number field, first, a pair of two pixel data u11 as a pair of G (green) and B (blue) is outputted as a 1st row, then, as a 2nd row, a pair of two pixel data u21 of R (red) and G (green) is outputted. Subsequently, as a 3rd row, a pair of two pixel data u31 of G and B is outputted, then, as a 4th row, a pair of two pixel data u41 of R and G is outputted. As a result, a set of the output, which is odd-number-field pixel data U1 as the first unit, is outputted.

Subsequently, in a second scanning unit (a second unit) a2 of the odd-number field, odd-number-field pixel data U2 is outputted in the same manner. Then, in a third scanning unit (a third unit) a3 of the odd-number field, odd-number-field pixel data U3 is outputted as well in the same manner.

When the vertical and horizontal scanning in the odd-number field is completed, scanning in the even-number field is started. The reading-out line of the even-number filed is shifted by one line from the reading-out line of the odd-number field.

In a first unit b1 of the even-number field, first, a pair of two pixel data w11 of B (blue) and G (green) is outputted as a 1st row, then, as a 2nd row, a pair of two pixel data w21 of G (green) and R (red) is outputted. Subsequently, as a 3rd row, a pair of two pixel data w31 of B and G is outputted, then, as a 4th row, a pair of two pixel data w41 of G and R is outputted. As a result, a set of the output, which is even-number-field pixel data W1 as the first unit, is outputted.

Subsequently, in a second scanning unit b2 of the even-number field, even-number-field pixel data W2 is outputted in the same manner. Then, in a third scanning unit b3 of the even-number field, even-number-field pixel data U3 is outputted as well in the same manner.

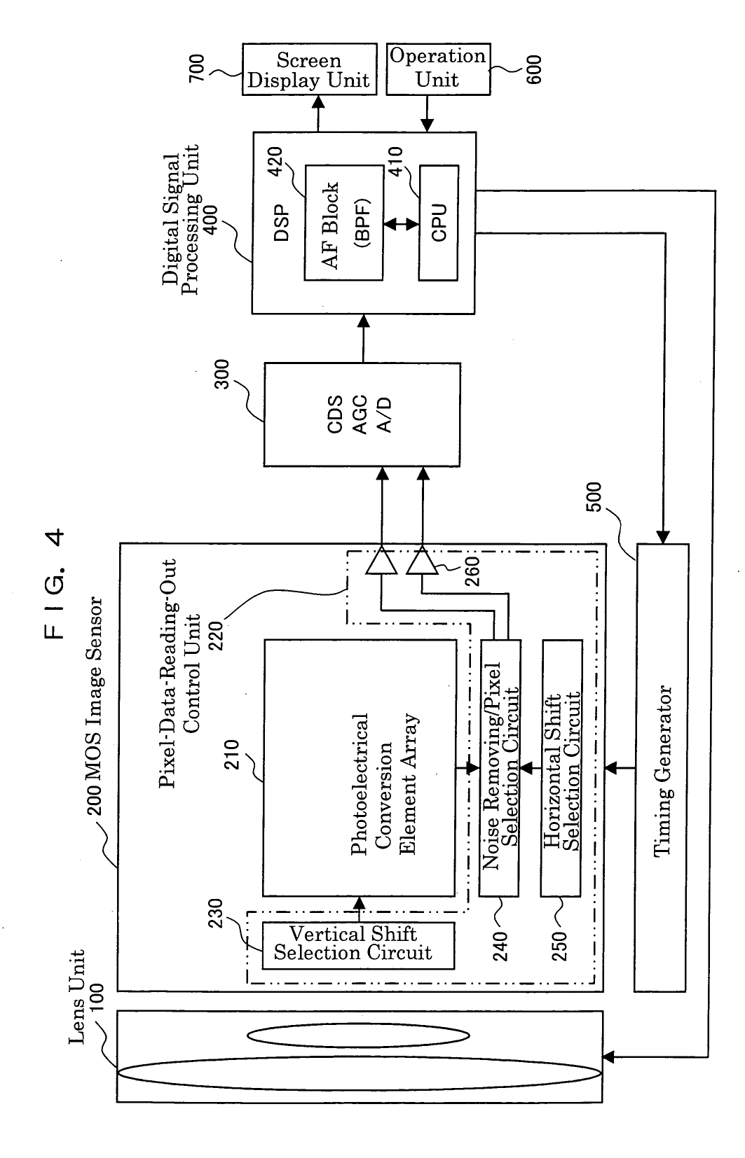

FIG. 4 is an exploded view for more specifically illustrating the configuration of FIG. 1 described above.

In FIG. 4, numeral reference 100 is a lens unit, 200 is a MOS image sensor, 300 is a CDS-AGC-A/D processing unit, 400 is a digital signal processing unit, 500 is a timing generator, 600 is an operation unit, and 700 is a screen display unit. The lens unit 100 corresponds to the optical system E1. The image sensor 200 comprises a photoelectrical conversion element array 210 and a pixel-data-reading-out control unit 220. The element array 210 corresponds to the element array E2 and the reading-out control unit 220 corresponds to the reading-out control unit E3. The reading-out control unit 220 comprises a vertical shift selection circuit 230, a noise removing/pixel selection circuit 240, a horizontal shift selection circuit 250 and an output amplifier 260. The output amplifier 260 may have one channel or two channels. The CDS-AGC-A/D processing unit 300 and the digital signal processing unit 400 correspond to the image processing unit E4. The digital signal processing unit 400 comprises a CPU 401 and an AF block 420.

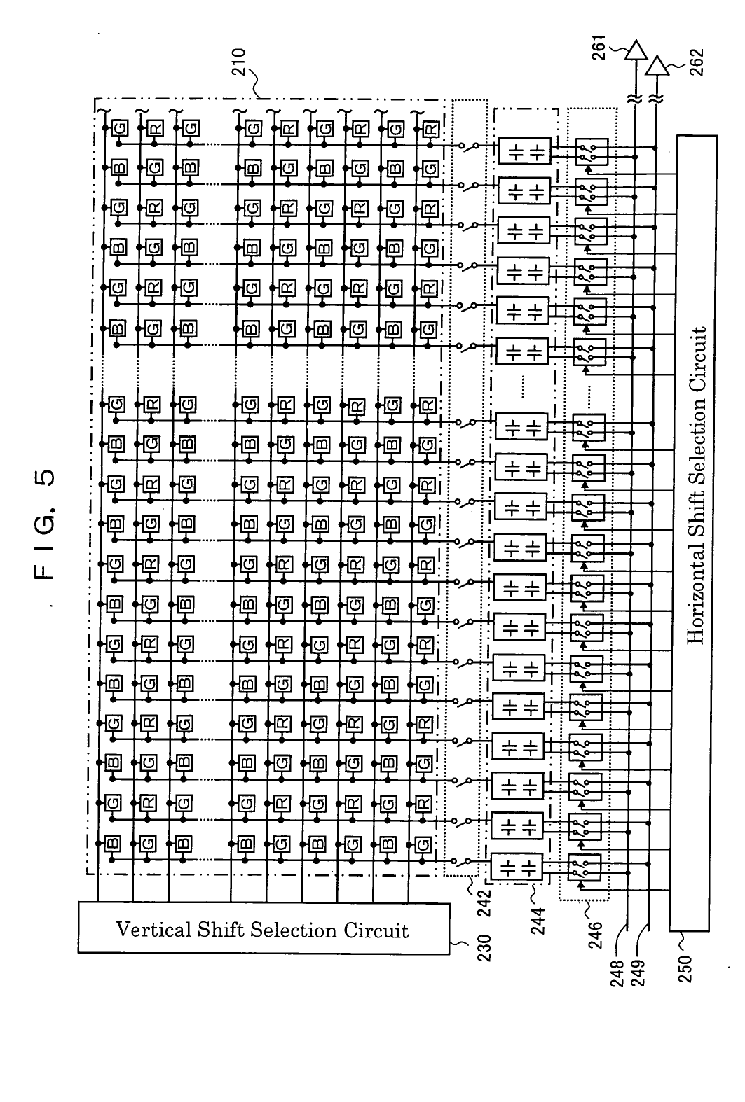

FIG. 5 is a block diagram for showing the more-detailed configuration of the noise removing/pixel selection circuit 240. In FIG. 5, numeral reference 242 is a vertical transfer switch circuit, 244 is a signal voltage holding circuit, 246 is a horizontal transfer switch circuit, 248 is a signal output line to a first output amplifier, and 249 is a signal output line to a second output amplifier 262.

The vertical shift selection circuit 230 selects the scanning unit, that is, two horizontal scanning lines. The pixel data of the pixels on the first scanning line is outputted from the first output amplifier 261, and the pixel data of the pixels on the second scanning line is outputted from the second output amplifier 262.

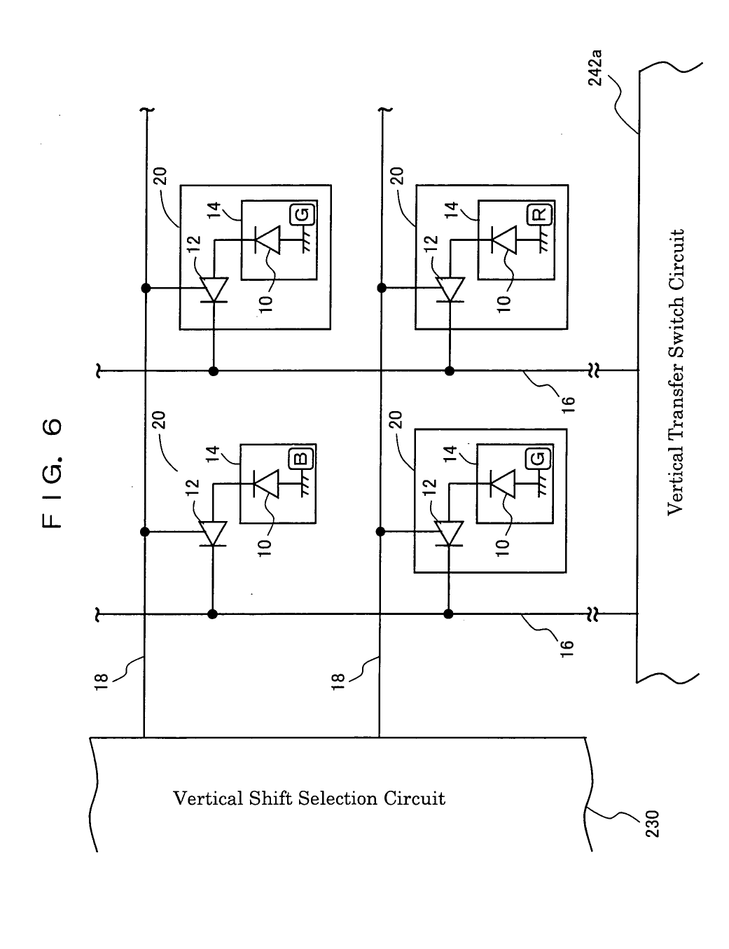

FIG. 6 is a fragmentary enlarged view of the element array 210. A single pixel 20 is formed with a photodiode 10, a cell amplifier 12 and a color filter 14. The anode of the photodiode 10 is earthed, the cathode is connected to the input of the cell amplifier 12, and the output of the cell amplifier 12 is connected to a longitudinal reading-out line 16. The control terminal of the cell amplifier 12 is connected to a scanning line 18 extended from the vertical shift selection circuit 230.

The color filter 14 is disposed in the front face of the photodiode 10. The color filter 14 constitutes a Bayer pattern (G, R, B, G) with a group of four pixels. With four pixels arranged in two lines and two rows being a single unit, in which the first G (green) and R (red) as well as B (blue) and the second G (green) are arranged in horizontal direction, and the first G (green) and B (blue) as well as R (red) and the second G (green) are arranged in the vertical direction, a large number of the units of four pixels are arranged in matrix form in longitudinal and lateral directions.

(Whole-Pixel-Reading-Out Mode)

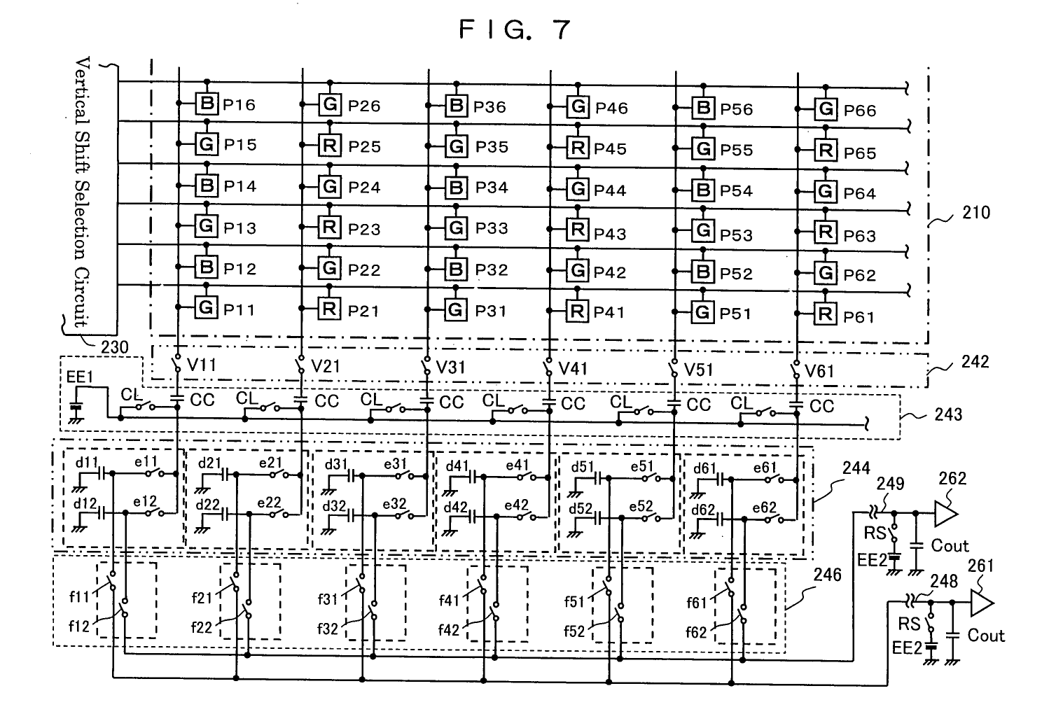

The operation of the whole-pixel-reading-out mode will be described by referring to FIG. 7. FIG. 7 is an enlarged view of the circuit structure for reading out the pixel data. The noise removing circuit 243 is also illustrated in the figure (omitted in FIG. 5).

In the initial state of reading-out, a reset switch RS is closed once so that a signal output condenser Cout is reset to VVD level of a reset power source EE2. After the reset, the reset switch RS is opened. Also, a clamp switch CL is closed once so that the all the clamp condensers CC are reset. After the reset, the clamp switch CL is opened.

The 1st line of the element array E2 is selected by the vertical shift selection circuit 230. Vertical transfer switches V11, V21, V31 - - - are closed simultaneously, while the voltage signals in pixels P11, P21, P31 - - - are charged respectively to condensers d11, d21, d31 - - - .

Subsequently, by closing horizontal transfer switches f11, f21, f31 - - - in order, the pixel data of the whole pixels on two lines are outputted through two channels of the signal output condenser Cout and the output amplifier 261.

Specifically, first, by closing the first horizontal transfer switch f11, the pixel data of the pixel P11 on the 1st line and 1st row, which is held by the condenser d11, is outputted through the output condenser Cout and the output amplifier 26. Then, by closing the second horizontal transfer switch f21, the pixel data of the pixel P21 on the 1st line and 2nd row, which is held by the condenser d21, is outputted. Subsequently, by closing the third horizontal transfer switch f31, the pixel data of the pixel P31 on the 1st line and 3rd row, which is held by the condenser d31, is outputted. In the same manner, by closing the horizontal transfer switches f41, f51, f61 - - - in order, the pixel data of the pixels P41, P51, P61 - - - on the 1st line and fourth, fifth, sixth rows, which are held by the condensers d41, d51, d61 - - - , are outputted. Thereby, the pixel data of the whole pixels on the 1st line is outputted (see Y1 in FIG. 2).

After completing the reading-out of the pixel data of the whole pixels on the 1st line, it then shifts to read out the pixel data on the 2nd line (see Y2 in FIG. 2) after canceling noise. That is, by applying the clamp direct current power source EE1 through closing the clamp switch CL, all the clamp condensers CC are reset to initial potential.

A pixel is formed with a combination of a photodiode and a cell amplifier (floating diffusion amplifier). The electric potential accumulated in the photodiode is outputted in a form of voltage through the cell amplifier. There is dispersion in the threshold voltage VT of the transistor of the cell amplifier, which becomes offset components for deteriorating the image quality (for example, vertical lines). This is called noise and it is a role of the noise removing circuit 243 to cancel the noise. As the clamp condenser, MOS gate capacity can be used. After resetting the clamp condenser, it then shifts to read out the pixel data on the next line (see Y3 in FIG. 2) by opening the clamp switch CL.

For reading out the pixel data on the next line, the selected line is shifted by one in the vertical shift selection circuit 230. The same operation as described above is repeated hereinafter. The pixel data for the whole pixels on one line is read out in order.

By repeating the operation of reading out the pixel data of the whole pixels on each line until the last line by shifting the selected line by one, the whole pixel data for one frame is read out.

(Interlace Reading-Out in Odd-Number Field)

The operation of the interlace reading-out will be described by referring to FIG. 7. FIG. 7 is an enlarged view showing the circuit structure for reading out the pixel data of pixels on two scanning lines.

The 1st line of the element array 210 is selected by the vertical shift selection circuit 230. All the vertical transfer switches V11, V21, V31, V41 - - - in the vertical transfer switch circuit 242 are simultaneously closed and also all of the first transmission switches e11, e21, e31, e41 - - - in the signal voltage holding circuit 244 are closed. Thereby the voltage signals in the G (green) and R (red) pixels P11, P21, P31, P41 - - - on the 1st line are respectively charged to the first condensers d11, d21, d31, d41 - - - of the signal voltage holding circuit 244. Then, all the clamp switches CC are reset through ON-OFF operation of the clamp switches CL of the noise removing circuit 243.

Subsequently, the vertical shift selection circuit 230 shifts the selected line by one for selecting the 2nd line. All the vertical transfer switches V11, V21, V31, V41 - - - in the vertical transfer switch circuit 242 are simultaneously closed and also all of the second transmission switches e12, e22, e32, e42 - - - in the signal voltage holding circuit 244 are simultaneously closed. Thereby the voltage signals in the B (blue) and G (green) pixels P12, P22, P32, P42 - - - on the 2nd line are respectively charged to the second condensers d12, d22, d32, d42 - - - of the signal voltage holding circuit 244. Then, all the clamp switches CC are reset through ON-OFF operation of the clamp switches CL of the noise removing circuit 243.

Thereby, the pixel data of G (green) on the 1st line and 1st row is held in the condenser d11, and the pixel data of R (red) on the 1st line and 2nd row is held in the condenser d21. Also, the pixel data of G (green) on the 1st line and 3rd row is held in the condenser d31, and the pixel data of R (red) on the 1st line and 4th row is held in the condenser d41. In other rows, the same relations can be found. Moreover, the pixel data of B (blue) on the 2nd line and 1st row is held in the condenser d12, the pixel data of G (green) on the 2nd line and 2nd row is held in the condenser d22. Also, the pixel data of B (blue) on the 2nd line and 3rd row is held in the condenser d32, and the pixel data of G (green) on the 2nd line and 4th row is held in the condenser d42. The same relations can be found in other rows as well.

Subsequently, by simultaneously operating the horizontal transfer switches f11, f12 on the 1st row, the pixel data of G (green) held in the condenser d11 is charged to the signal output condenser Cout to be outputted from the first amplifier 261. At the same time, the pixel data of B (blue) held in the condenser d12 is charged to the signal output condenser Cout to be outputted from the second output amplifier 262. In FIG. 3, these correspond to the pair of two pixel data u11 of the first unit in the odd-number field.

Then, by simultaneously operating the horizontal transfer switch f21, f22 on the 2nd row, the pixel data of R (red) held in the condenser d21 is outputted from the first amplifier 261, and the pixel data of G (green) held in the condenser d22 is outputted from the second amplifier 262. In FIG. 3, these correspond to the pair of two pixel data u21 of the first unit in the odd-number field.

Subsequently, by simultaneously operating the horizontal transfer switch f31, f32 on the 3rd row, the pixel data of G (green) held in the condenser d31 is outputted from the first amplifier 261, and the pixel data of B (blue) held in the condenser d32 is outputted from the second amplifier 262. In FIG. 3, these correspond to the pair of two pixel data u31 of the first unit in the odd-number field.

Thereby, the pixel data of the 1st line and the 2nd line as a pair on two lines as the first unit in the odd-number field shown in FIG. 3 are parallel-outputted simultaneously through two channels. This is the odd-number-field pixel data U1.

Then, the output target unit is shifted from a1 to a2 by the vertical shift selection circuit 230 and the same operation as described above is repeated. Thereby, the pixel data of the 3rd line and the 4th line as a pair on two lines as the second unit in the odd-number field shown in FIG. 3 are parallel-outputted simultaneously through two channels. This is the odd-number-field pixel data U2.

Then, the output target unit is shifted from a2 to a3 by the vertical shift selection circuit 230 and the same operation as described above is repeated. Thereby, the pixel data of the 5th line and the 6th line as a pair on two lines as the third unit in the odd-number field shown in FIG. 3 are parallel-outputted simultaneously through two channels. This is the odd-number-field pixel data U3.

In this manner, simultaneous parallel output of (1st line, 2nd line), that of (3rd line, 4th line), that of (5th line, 6th line), etc. are carried out in order. Thereby the output of pixel data for the whole pixels in the odd-number field is completed. Subsequently, it shifts to the even-number field.

(Interlace Reading-Out in Even-Number Field)

For the interlace reading out in the eve-number field, the unit of two lines as a pair is shifted by one line from that of the odd-number field.

The 2nd line of the element array 210 is selected by the vertical shift selection circuit 230. All the vertical transfer switches V11, V21, V31, V41 - - - in the vertical transfer switch circuit 242 are simultaneously closed and also all of the first transmission switches e11, e21, e31, e41 - - - in the signal voltage holding circuit 244 are closed. Thereby the voltage signals in the B (blue) and G (green) pixels P12, P22, P32, P42 - - - on the 2nd line are respectively charged to the first condensers d11, d21, d31, d41 - - - of the signal voltage holding circuit 244. Then, all the clamp switches CC are reset through ON-OFF operation of the clamp switches CL of the noise removing circuit 243.

Subsequently, the vertical shift selection circuit 230 shifts the selected line by one for selecting the 3rd line. All the vertical transfer switches V11, V21, V31, V41 - - - are simultaneously closed and also all of the second transmission switches e12, e22, e32, e42 - - - are simultaneously closed. Thereby the voltage signals in the G (green) and R (red) pixels P13, P23, P33, P43 - - - on the 3rd line are respectively charged to the second condensers d12, d22, d32, d42 - - - . Then, all the clamp switches CC are reset through ON-OFF operation of the clamp switches CL.

Thereby, the pixel data of B (blue) on the 2nd line and 1st row is held in the condenser d11, the pixel data of G (green) on the 2nd line and 2nd row is held in the condenser d21. Also, the pixel data of B (blue) on the 2nd line and 3rd row is held in the condenser d31, and the pixel data of G (green) on the 2nd line and 4th row is held in the condenser d41. The same relations can be found n other rows as well. Moreover, the pixel data of G (green) on the 3rd line and 1st row is held in the condenser d12, the pixel data of R (red) on the 3rd line and 2nd row is held in the condenser d22. Also, the pixel data of G (green) on the 3rd line and 3rd row is held in the condenser d32, and the pixel data of R (red) on the 3rd line and 4th row is held in the condenser d42. The same relations can be found in other rows as well.

Subsequently, by simultaneously switching the horizontal transfer switches f11, f12 on the 1st row, the pixel data of B (blue) held in the condenser d11 is outputted from the first amplifier 261, and the pixel data of G (green) held in the condenser d12 is outputted from the second output amplifier 262. In FIG. 3, these correspond to the pair of two pixel data w11 of the first unit in the even-number field.

Then, by simultaneously switching the horizontal transfer switches f21, f22 on the 2nd row, the pixel data of G (green) held in the condenser d21 is outputted from the first amplifier 261, and the pixel data of R (red) held in the condenser d22 is outputted from the second amplifier 262. In FIG. 3, these correspond to the pair of two pixel data w21 of the first unit in the odd-number field.

Subsequently, by simultaneously operating the horizontal transfer switches f31, f32 on the 3rd row, the pixel data of B (blue) held in the condenser d31 is outputted from the first amplifier 261, and the pixel data of G (green) held in the condenser d32 is outputted from the second amplifier 262. In FIG. 3, these correspond to the pair of two pixel data w31 of the first unit in the even-number field.

Thereby, the pixel data of the 2nd line and the 3rd line as a pair on two lines as the first unit in the even-number field shown in FIG. 3 are parallel-outputted simultaneously through two channels. This is the even-number-field pixel data W1.

Then, the output target unit is shifted from b1 to b2 by the vertical shift selection circuit 230 and the same operation as described above is repeated. Thereby, the pixel data of the 4th line and the 5th line as a pair on two lines as the second unit in the even-number field shown in FIG. 3 are parallel-outputted simultaneously through two channels. This is the even-number-field pixel data W2.

Then, the output target unit is shifted from b2 to b3 by the vertical shift selection circuit 230 and the same operation as described above is repeated. Thereby, the pixel data of the 6th line and the 7th line as a pair on two lines as the third unit in the even-number field shown in FIG. 3 are parallel-outputted simultaneously through two channels. This is the even-number-field pixel data W3.

In this manner, simultaneous parallel output of (2nd line, 3rd line), that of (4th line, 5th line), that of (6th line, 7th line), etc. are carried out in order. Thereby the output of pixel data for the whole pixels in the even-number field is completed. Subsequently, it shifts to the odd-number field.

The simultaneous parallel output in the odd-number field is performed on (1st line, 2nd line), on (3rd line, 4th line), and on (5th line, 6th line). The simultaneous parallel output in the even-number field is performed on (2nd line, 3rd line), on (4th line, 5th line), and on (6th line, 7th line). Each line is selected in both the odd-number field and the even-number field, and the same line is the odd-number field and the even-number field is outputted through different channels.

As described above, it is the interlace reading-out with the pair of two lines being a unit, so that it enables to achieve highly fine interlace moving pictures of smooth movement with high pixels by fast reading-out as well as highly fine still pictures. Thus, the quality of moving images can be remarkably improved.

This effect is achieved by simply applying a little contrivance to the reading-out control unit in regards to the output form of the pixel data, which reads out the pixel data from the photoelectrical conversion element array. Therefore, even though the remarkable improvement is achieved in the moving image quality as described above, complication of the structure can be suppressed so that advantages in terms of product costs can be expected.

This embodiment can also be applied to the simultaneous parallel output through four channels.

### Second Embodiment

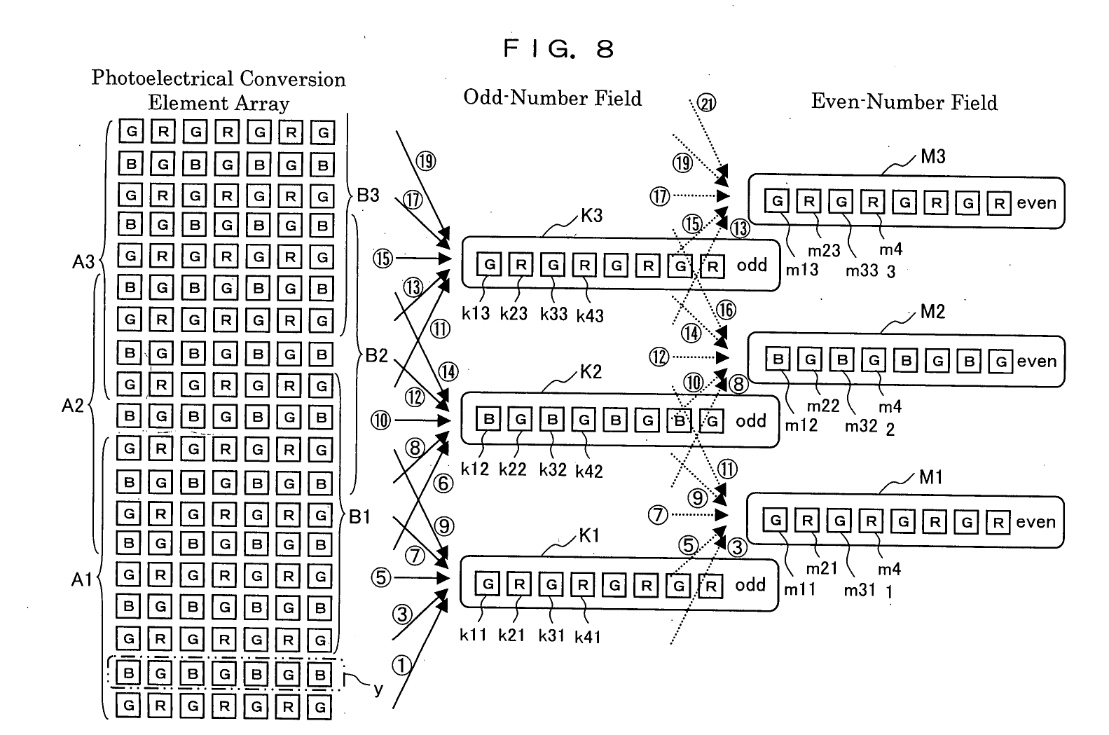

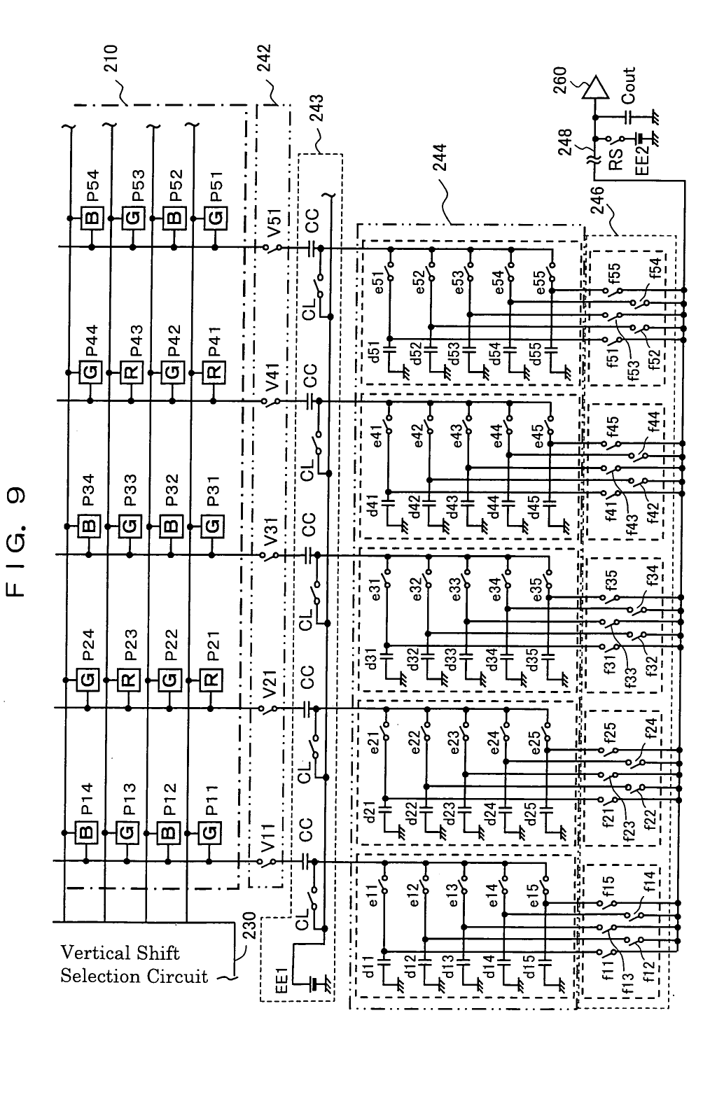

Next, a solid state image pickup device according to a second embodiment of the present invention will be described by referring to FIG. 8 and FIG. 9. FIG. 8 is an illustration for describing the interlace reading-out of vertically mixed five pixels. FIG. 9 is an enlarged view showing the circuit structure for reading out the pixel data of the pixels on the five scanning lines.

(Interlace Reading-out in Odd-Number Field)

The first output target in the odd-number field is a first unit of the five lines as a group. The first unit A1 is an aggregation of the 1st line, 3rd line, 5th line, 7th line and 9th line.

First, the 1st line A1 of the first unit in the element array 210 is selected by the vertical shift selection circuit 230. All the vertical transfer switches V11, V21, V31, V41 - - - in the vertical transfer switch circuit 242 are simultaneously closed and also all of the first transmission switches e11, e21, e31, e41 - - - in the signal voltage holding circuit 244 are closed. Thereby the voltage signals in the G (green) and R (red) pixels P11, P21, P31, P41 - - - on the 1st line are respectively charged to the first condensers d11, d21, d31, d41 - - - of the signal voltage holding circuit 244. Then, all the clamp switches CC are reset through ON-OFF operation of the clamp switches CL of the noise removing circuit 243.

Subsequently, the vertical shift selection circuit 230 shifts the selected line by two for selecting the 3rd line. All the vertical transfer switches V11, V21, V31, V41 - - - are simultaneously closed and also all of the second transmission switches e12, e22, e32, e42 - - - are simultaneously closed. Thereby the voltage signals in the G (green) and R (red) pixels P13, P23, P33, P43 - - - on the 3rd line are respectively charged to the second condensers d12, d22, d32, d42 - - - . Then, all the clamp switches CC are reset.

Then, the vertical shift selection circuit 230 shifts the selected line by two for selecting the 5th line. All the vertical transfer switches V11, V21, V31, V41 - - - are simultaneously closed and also all of the third transmission switches e13, e23, e33, e43 - - - are simultaneously closed. Thereby the voltage signals in the G (green) and R (red) pixels P15, P25, P35, P45 - - - on the 5th line are respectively charged to the third condensers d13, d23, d33, d43 - - - . Then, all the clamp switches CC are reset.

Subsequently, the vertical shift selection circuit 230 shifts the selected line by two for selecting the 7th line. All the vertical transfer switches V11, V21, V31, V41 - - - are simultaneously closed and also all of the fourth transmission switches e14, e24, e34, e44 - - - are simultaneously closed. Thereby the voltage signals in the G (green) and R (red) pixels P17, P27, P37, P47 - - - on the 7th line are respectively charged to the fourth condensers d14, d24, d34, d44 - - - . Then, all the clamp switches CC are reset.

Then, the vertical shift selection circuit 230 shifts the selected line by two for selecting the 9th line. All the vertical transfer switches V11, V21, V31, V41 - - - are simultaneously closed and also all of the fifth transmission switches e15, e25, e35, e45 - - - are simultaneously closed. Thereby the voltage signals in the G (green) and R (red) pixels P19, P29, P39, P49 - - - on the 9th line are respectively charged to the fifth condensers d15, d25, d35, d45 - - - . Then, all the clamp switches CC are reset.

In this manner as described above, as for the group of the pixels on the 1st line, 3rd line, 5th line, 7th line and 9th line, five pixel data of G (green) on the 1st row are respectively held by the condensers d11, d12, d13, d14, d15, five pixel data of R (red) on the 2nd row are respectively held by the condensers d21, d22, d32, d24, d25. Also, five pixel data of G (green) on the 3rd row are respectively held by the condensers d31, d32, d33, d34, d35, and five pixel data of R (red) on the 4th row are respectively held by the condensers d41, d42, d43, d44, d45. The same relations can be found in other rows as well.

In the 1st line, 3rd line, 5th line, 7th line and 9th line, the five pixels on the 1st row are all G (green) pixels and the pixel data of those are held by the condensers d11, d12, d13, d14, d15. Thus, by simultaneously operating the five horizontal transfer switches f11, f12, f13, f14, f15 corresponding to the condensers for charging the signal output condensers Cout, the pixel data of five G (green) pixels are mixed and the five-pixel-mixed-pixel-data of G (green) is outputted from the output amplifier 260. In FIG. 8, this corresponds to the five-pixel-mixed-pixel data k11 of G (green) of the first unit.

In the 1st line, 3rd line, 5th line, 7th line and 9th line, the five pixels on the 2nd row are all R (red) pixels and the pixel data of those are held by the condensers d21, d22, d23, d24, d25. Thus, by simultaneously operating the five horizontal transfer switches f21, f22, f23, f24, f25 corresponding to the condensers for charging the signal output condensers Cout, the pixel data of five R (red) pixels are mixed and the five-pixel-mixed-pixel-data of R (red) is outputted from the output amplifier 260. In FIG. 8, this corresponds to the five-pixel-mixed-pixel data k21 of R (red) of the first unit.

In the same manner, by simultaneously operating the five horizontal transfer switches f31, f32, f33, f34, f35 on the 3rd row, the pixel data of G (green) held by the condensers d31, d32, d33, d34, d35 are mixed to be outputted from the output amplifier 260 as the five-pixel-mixed-pixel data k31. Then, by simultaneously operating the five horizontal transfer switches f41, f42, f43, f44, f45 on the 4th row, the pixel data of R (red) held by the condensers d41, d42, d43, d44, d45 are mixed to be outputted from the output amplifier 260 as the five-pixel-mixed-pixel data k41.

Thereby, the five-pixel-mixed-pixel-data K1 (k1, k21, k31, k41 - - - ) is outputted, in which the five pixels of the pixel data by each row in the 1st line, 3rd line, 5th line, 7th line and 9th line of the first unit as a group of five lines in the odd-number field in FIG. 8 are mixed.

Subsequently, the output target unit of five lines as a group is shifted from A1 to A2 by the vertical shift selection circuit 230. The second unit A2 is an aggregation of the 6th line, 8th line, 10th line, 12th line, and 14th line. By repeating the same operation described above in the second unit A2, the five-pixel-mixed-pixel-data K2 (k12, k22, k32, k42 - - - ), in which five pixels on the five lines of the second unit as a group of five lines in the odd-number field of FIG. 8 are mixed, is outputted.

Then, the output target unit of five lines as a group is shifted from A2 to A3 by the vertical shift selection circuit 230. The third scanning unit (third unit) A3 is an aggregation of the 11th line, 13th line, 15th line, 17th line, and 19th line. By repeating the same operation described above in the third unit A3, the five-pixel-mixed-pixel-data K3 (k13, k23, k33, k43 - - - ), in which five pixels on the five lines of the third unit as a group of five lines in the odd-number field of FIG. 8 are mixed, is outputted.

By repeating the operations as described above, output of the pixel data in the odd-number field is completed.

In the odd-number field described above, the gravitational center of the five-pixel-mixed-pixel-data K1 of the first unit A1 is the 5th line, that of the five-pixel-mixed-pixel-data K2 of the second unit A2 is the 10th line, and that of the five-pixel-mixed-pixel-data K3 of the third unit A3 is the fifteenth line. In other words, the gravitational center shifts from fifth, tenth, fifteenth line - - - by skipping five lines.

Next, it shifts to the even-number field.

(Interlace Reading-out in Even-Number Field)

For the interlace reading-out in the even-number field, the unit of five lines as a group is shifted by two lines from that of the odd-number field. The first output target in the even-number field is a first unit B1. The first unit B1 is an aggregation of the 3rd line, 5th line, 7th line, 9th line and 11th line.

First, the 3rd line in the element array 210 is selected by the vertical shift selection circuit 230. All the vertical transfer switches V11, V21, V31, V41 - - - are simultaneously closed and also all of the first transmission switches e11, e21, e31, e41 - - - are simultaneously closed. Thereby the voltage signals in the G (green) and R (red) pixels P13, P23, P33, P43 - - - on the 3rd line are respectively charged to the first condensers d11, d21, d31, d41 - - - . Then, all the clamp switches CC are reset.

Subsequently, the vertical shift selection circuit 230 shifts the selected line by two for selecting the 5th line. All the vertical transfer switches V11, V21, V31, V41 - - - are simultaneously closed and also all of the second transmission switches e12, e22, e32, e42 - - - are simultaneously closed. Thereby the voltage signals in the G (green) and R (red) pixels P15, P25, P35, P45 - - - on the 5th line are respectively charged to the second condensers d12, d22, d32, d42 . Then, all the clamp switches CC are reset.

Further, the vertical shift selection circuit 230 shifts the selected line by two for selecting the 7th line. All the vertical transfer switches V11, V21, V31, V41 - - - are simultaneously closed and also all of the third transmission switches e13, e23, e33, e43 - - - are closed. Thereby the voltage signals in the G (green) and R (red) pixels P17, P27, P37, P47 - - - on the 7th line are respectively charged to the third condensers d13, d23, d33, d43 - - - . Then, all the clamp switches CC are reset.

Subsequently, the vertical shift selection circuit 230 shifts the selected line by two for selecting the 9th line. All the vertical transfer switches V11, V21, V31, V41 - - - are simultaneously closed and also all of the fourth transmission switches e14, e24, e34, e44 - - - are simultaneously closed. Thereby the voltage signals in the G (green) and R (red) pixels P19, P29, P39, P49 - - - on the 9th line are respectively charged to the fourth condensers d14, d24, d34, d44 . Then, all the clamp switches CC are reset.

Then, the vertical shift selection circuit 230 shifts the selected line by two for selecting the 11th line. All the vertical transfer switches V11, V21, V31, V41 - - - are simultaneously closed and also all of the fifth transmission switches e15, e25, e35, e45 - - - are simultaneously closed. Thereby the voltage signals in the G (green) and R (red) pixels P111, P211, P311, P411 - - - on the 11th line are respectively charged to the fifth condensers d15, d25, d35, d45 - - - . Then, all the clamp switches CC are reset.

In this manner as described above, as for the group of the pixels on the 3rd line, 5th line, 7th line, 9th line and 11th line, five pixel data of G (green) on the 1st row are respectively held by the condensers d11, d12, d13, d14, d15, five pixel data of R (red) on the 2nd row are respectively held by the condensers d21, d22, d32, d24, d25. Also, five pixel data of G (green) on the 3rd row are respectively held by the condensers d31, d32, d33, d34, d35, and five pixel data of R (red) on the 4th row are respectively held by the condensers d41, d42, d43, d44, d45. The same relations can be found in other rows as well.

By simultaneously operating the five horizontal transfer switches f11, f12, f13, f14, f15, the pixel data of the five G (green) pixels held by the condensers d11, d12, d13, d14, d15 are charged to the signal output condensers Cout for mixing, and the five-pixel-mixed-pixel-data m11 of G (green) is outputted from the output amplifier 260.

Then, by simultaneously operating the five horizontal transfer switches f21, f22, f23, f24, f25, the pixel data of the five R (red) pixels held by the condensers d21, d22, d23, d24, d25 are charged to the signal output condensers Cout for mixing, and the five-pixel-mixed-pixel-data m12 of R (red) is outputted from the output amplifier 260.

In the same manner as described above, by simultaneously operating the five horizontal transfer switches f31, f32, f33, f34, f35, the pixel data of G (green) held by the condensers d31, d32, d33, d34, d35 are mixed to be outputted from the output amplifier 260 as the five-pixel-mixed-pixel data m31. Then, by simultaneously operating the five horizontal transfer switches f41, f42, f43, f44, f45, the pixel data of R (red) held by the condensers d41, d42, d43, d44, d45 are mixed to be outputted from the output amplifier 260 as the five-pixel-mixed-pixel data m41.

Thereby, the five-pixel-mixed-pixel-data M1 (m11, m21, m31, m41 - - - ) is outputted, in which the five pixels of the pixel data by each row in the 3rd line, 5th line, 7th line, 9th line and 11th line of the first unit as a group of five lines in the even-number field in FIG. 8 are mixed.

Subsequently, the output target unit of five lines as a group is shifted from B1 to B2 by the vertical shift selection circuit 230. The second unit B2 is an aggregation of the 8th line, 10th line, 12th line, 14th line and 16th line. By repeating the same operation described above in the second unit B2, the five-pixel-mixed-pixel-data M2 (m12, m22, m32, m42 - - - ), in which five pixels on the five lines of the second unit as a group of five lines in the even-number field of FIG. 8 are mixed, is outputted.

Then, the output target unit of five lines as a group is shifted from B2 to B3 by the vertical shift selection circuit 230. The third unit B3 is an aggregation of the thirteenth line, 15th line, 17th line, 19th line and 21st line. By repeating the same operation described above in the third unit B3, the five-pixel-mixed-pixel-data M3 (m13, m23, m33, m43 - - - ), in which five pixels on the five lines of the third unit as a group of five lines in the even-number field of FIG. 8 are mixed, is outputted.

By repeating the operations as described above, output of the pixel data in the even-number field is completed.

In the even-number field described above, the gravitational center of the of the five-pixel-mixed-pixel-data M1 of the first unit B1 is the 7th line, that of the five-pixel-mixed-pixel-data M2 of the second unit B2 is the 12th line, and that of the five-pixel-mixed-pixel-data M3 of the third unit B3 is the 17th line. In other words, the gravitational center shifts from 7th, 12th, 17th line - - - by skipping five lines. The gravitational center may be the 8th, 13th, 18th line - - - by skipping five lines.

Next, it shifts to the even-number field. The 2nd line y is not employed.

As described above, it is the interlace reading-out with the group of five lines being a unit, so that it enables to achieve highly fine interlace moving pictures of smooth movement with high pixels by fast reading-out as well as highly fine still pictures. Thus, the quality of moving images can be remarkably improved.

This effect is achieved by simply applying a little contrivance to the reading-out control unit in regards to the output form of the pixel data, which reads out the pixel data from the photoelectrical conversion element array. Therefore, even though the remarkable improvement is achieved in the moving image quality as described above, complication of the structure can be suppressed so that advantages in terms of product costs can be expected.

This embodiment can also be applied to the simultaneous parallel output through two channels.

### Third Embodiment

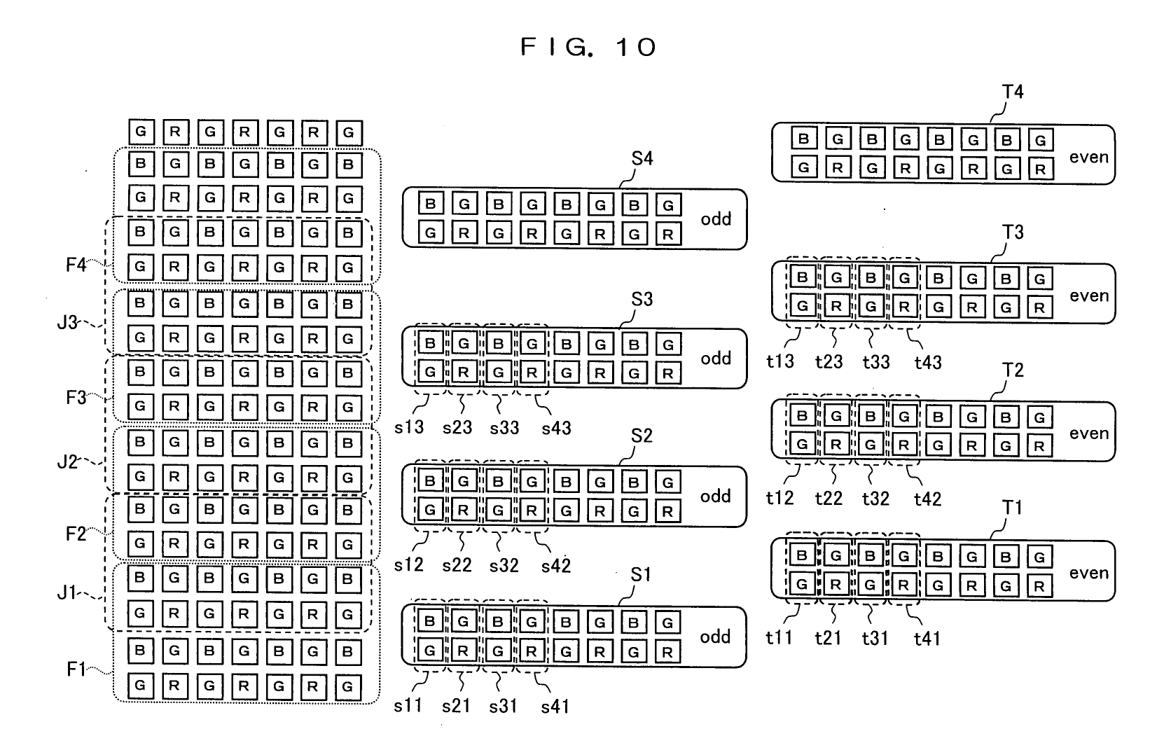

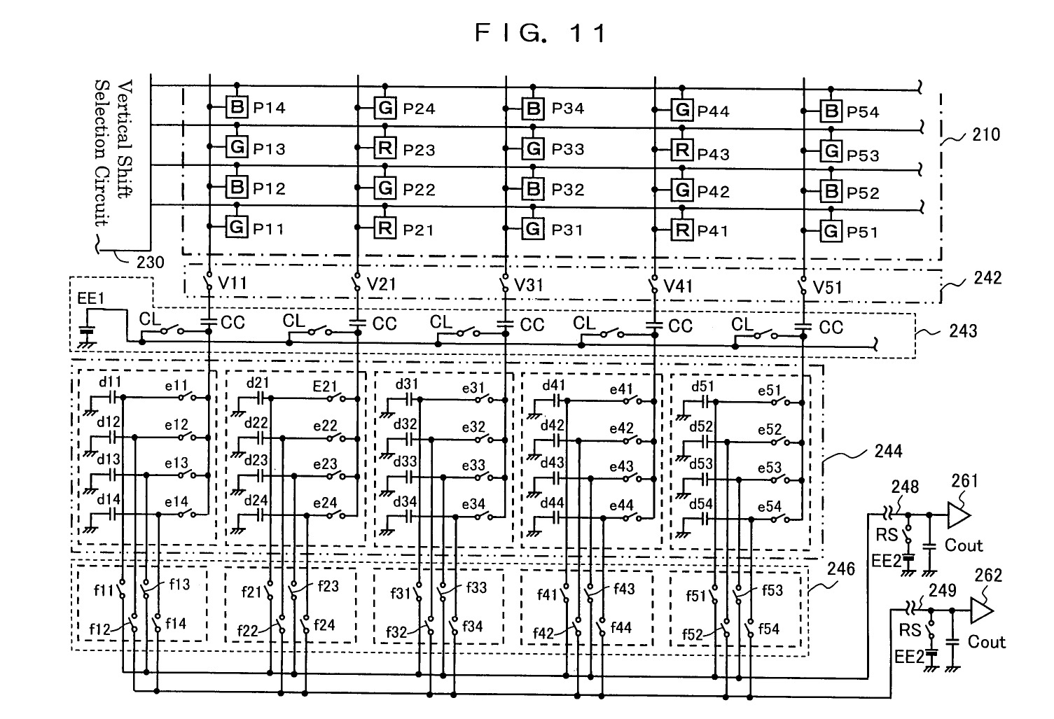

Next, a solid state image pickup device according to a third embodiment of the present invention will be described by referring to FIG. 10 and FIG. 11. FIG. 10 is an illustration for describing the interlace reading-out of vertically mixed two pixels. FIG. 11 is an enlarged view showing the circuit structure for reading out the pixel data of the pixels on the four scanning lines.

The operation of the whole-pixel-reading-out mode is the same as the case of the first embodiment.

(Interlace Reading-Out in Odd-Number Field)

In the same manner as described above, the repeated pixel data of G (green) and R (red) on the 1st line are held by the condensers d11, d21, d31, d41 - - - , and the repeated pixel data of B (blue) and G (green) on the 2nd line are held by the condensers d12, d22, d32, d42 - - - . Also, the repeated data of G (green) and R (red) on the 3rd line are held by the condensers d13, d23, d33, d43 - - - and the repeated pixel data of B (blue) and G (green) on the 4th line are held by the condensers d14, d24, d34, d44 - - - .

By simultaneously operating the horizontal transfer switches f11, f13, the pixel data of the two G (green) pixels held by the condensers d11, d13 are mixed, and the two-pixel-mixed-pixel-data of G (green) is outputted from the first amplifier 261. At the same time, by simultaneously operating the horizontal transfer switches f12, f14, the pixel data of the two B (blue) pixels held by the condensers d12, d14 are mixed, and the two-pixel-mixed-pixel-data of B (blue) is outputted from the second amplifier 262. In FIG. 10, these data correspond to two two-pixel-mixed-pixel-data s11 of G (green) and B (blue) of the first unit as a pair.

Then, by simultaneously operating the horizontal transfer switches f21, f23, the pixel data of the two R (red) pixels held by the condensers d21, d23 are mixed, and the two-pixel-mixed-pixel-data of R (red) is outputted from the first amplifier 261. At the same time, by simultaneously operating the horizontal transfer switches f22, f24, the pixel data of the two G (green) pixels held by the condensers d22, d24 are mixed, and the two-pixel-mixed-pixel-data of G (green) is outputted from the second amplifier 262. In FIG. 10, these data correspond to two two-pixel-mixed-pixel-data s21 of R (red) and G (green) of the first unit as a pair.

Subsequently, by simultaneously operating the horizontal transfer switches f31, f33, the pixel data of the two G (green) pixels held by the condensers d31, d33 are mixed, and the two-pixel-mixed-pixel-data of G (green) is outputted from the first amplifier 261. At the same time, by simultaneously operating the horizontal transfer switches f32, f34, the pixel data of the two B (blue) pixels held by the condensers d32, d34 are mixed, and the two-pixel-mixed-pixel-data of B (blue) is outputted from the second amplifier 262. In FIG. 10, these data correspond to two two-pixel-mixed-pixel-data s31 of G (green) and B (blue) of the first unit as a pair.

Then, by simultaneously operating the horizontal transfer switches f41, f43, the pixel data of the two R (red) pixels held by the condensers d41, d43 are mixed, and the two-pixel-mixed-pixel-data of R (red) is outputted from the first amplifier 261. At the same time, by simultaneously operating the horizontal transfer switches f42, f44, the pixel data of the two G (green) pixels held by the condensers d42, d44 are mixed, and the two-pixel-mixed-pixel-data of G (green) is outputted from the second amplifier 262. In FIG. 10, these data correspond to two two-pixel-mixed-pixel-data s41 of R (red) and G (green) of the first unit as a pair.

Thereby, the two-pixel-mixed-pixel-data S1 (s11, s21, s31, s41 - - - ) is outputted, in which the two pixels of the pixel data by each row in the 1st line, 2nd line, 3rd line and 4th line of the first unit as a group of four lines in the odd-number field in FIG. 10 are mixed.

Subsequently, the output target unit of four lines as a group is shifted from F1 to F2 by the vertical shift selection circuit 230. The second unit F2 is an aggregation of the 5th line, 6th line, 7th line and 8th line. By repeating the same operation described above in the second unit F2, the two-pixel-mixed-pixel-data S2 (s12, s22, s32, s42 - - - ) of the second unit in the odd-number field of FIG. 10 is outputted.

Then, the output target unit of four lines as a group is shifted from F2 to F3 by the vertical shift selection circuit 230. The third unit F3 is an aggregation of the 9th line, 10th line, 11th line and 12th line. By repeating the same operation described above in the third unit F3, the two-pixel-mixed-pixel-data S3 (s13, s23, s33, s43 - - - ) of the third unit in the odd-number field of FIG. 10 is outputted.

By repeating the operations as described above, output of the pixel data in the odd-number field is completed.

In the odd-number field as described above, the gravitational center of the of the two-pixel-mixed-pixel-data S1 of the first unit F1 is the 2.5th line, that of the two-pixel-mixed-pixel-data S2 of the second unit F2 is the 6.5th line, and that of the two-pixel-mixed-pixel-data F3 of the third unit F3 is the 10.5th line. In other words, the gravitational center shifts by skipping four lines.

Now, it shifts to the even-number field.

(Interlace Reading-Out in Even-Number Field)

For the interlace reading-out in the even-number field, the unit of four lines as a group is shifted by two lines from that of the odd-number field. The first output target in the even-number field is a first unit J1. The first unit J1 is an aggregation of the 3rd line, 4th line, 5th line and 6th line.

In the same manner as described above, the repeated pixel data of G (green) and R (red) on the 1st line are held by the condensers d11, d21, d31, d41 - - - , and the repeated pixel data of B (blue) and G (green) on the 2nd line are held by the condensers d12, d22, d32, d42 - - - , and the repeated pixel data of G (green) and R (red) on the 3rd line are held by the condensers d13, d23, d33, d43 - - - and the repeated pixel data of B (blue) and G (green) on the 4th line are held by the condensers d14, d24, d34, d44 - - - . These are the same as the case of the odd-number field.

By simultaneously operating the horizontal transfer switches f11, f13, the pixel data of the two G (green) pixels held by the condensers d11, d13 are mixed, and the two-pixel-mixed-pixel-data of G (green) is outputted from the first amplifier 261. At the same time, by simultaneously operating the horizontal transfer switches f12, f14, the pixel data of the two B (blue) pixels held by the condensers d12, d14 are mixed, and the two-pixel-mixed-pixel-data of B (blue) is outputted from the second amplifier 262. In FIG. 10, these data correspond to two two-pixel-mixed-pixel-data t11 of G (green) and B (blue) of the first unit as a pair.

Then, by simultaneously operating the horizontal transfer switches f21, f23, the pixel data of the two R (red) pixels held by the condensers d21, d23 are mixed, and the two-pixel-mixed-pixel-data of R (red) is outputted from the first amplifier 261. At the same time, by simultaneously operating the horizontal transfer switches f22, f24, the pixel data of the two G (green) pixels held by the condensers d22, d24 are mixed, and the two-pixel-mixed-pixel-data of G (green) is outputted from the second amplifier 262. In FIG. 10, these data correspond to two two-pixel-mixed-pixel-data t21 of R (red) and G (green) of the first unit as a pair.

Subsequently, by simultaneously operating the horizontal transfer switches f31, f33, the pixel data of the two G (green) pixels held by the condensers d31, d33 are mixed, and the two-pixel-mixed-pixel-data of G (green) is outputted from the first amplifier 261. At the same time, by simultaneously operating the horizontal transfer switches f32, f34, the pixel data of the two B (blue) pixels held by the condensers d32, d34 are mixed, and the two-pixel-mixed-pixel-data of B (blue) is outputted from the second amplifier 262. In FIG. 10, these data correspond to two two-pixel-mixed-pixel-data t31 of G (green) and B (blue) of the first unit as a pair.

Then, by simultaneously operating the horizontal transfer switches f41, f43, the pixel data of the two R (red) pixels held by the condensers d41, d43 are mixed, and the two-pixel-mixed-pixel-data of R (red) is outputted from the first amplifier 261. At the same time, by simultaneously operating the horizontal transfer switches f42, f44, the pixel data of the two G (green) pixels held by the condensers d42, d44 are mixed, and the two-pixel-mixed-pixel-data of G (green) is outputted from the second amplifier 262. In FIG. 10, these data correspond to two two-pixel-mixed-pixel-data t41 of R (red) and G (green) of the first unit as a pair.

Thereby, the two-pixel-mixed-pixel-data T1 (t11, t21, t31, t41 - - - ) is outputted, in which the two pixels of the pixel data by each row in the 1st line, 2nd line, 3rd line and 4th line of the first unit as a group of four lines in the odd-number field in FIG. 10 are mixed.

Subsequently, the output target unit of four lines as a group is shifted from J1 to J2 by the vertical shift selection circuit 230. The second unit J2 is an aggregation of the 5th line, 6th line, 7th line and 8th line. By repeating the same operation described above in the second unit J2, the two-pixel-mixed-pixel-data T2 (t12, t22, t32, t42 - - - ) of the second unit in the odd-number field of FIG. 10 is outputted.

Then, the output target unit of four lines as a group is shifted from J2 to J3 by the vertical shift selection circuit 230. The third unit J3 is an aggregation of the 9th line, 10th line, 11th line and 12th line. By repeating the same operation described above in the third unit J3, the two-pixel-mixed-pixel-data T3 (t13, t23, t33, t43 - - - ) of the third unit in the odd-number field of FIG. 10 is outputted.

By repeating the operations as described above, output of the pixel data in the odd-number field is completed.

In the odd-number field as described above, the gravitational center of the two-pixel-mixed-pixel-data T1 of the first unit J1 is the 4.5th line, that of the two-pixel-mixed-pixel-data T2 of the second unit J2 is the 8.5th line, and that of the two-pixel-mixed-pixel-data T3 of the third unit J3 is the 12.5th line. In other words, the gravitational center shifts by skipping four lines.

Now, it shifts to the odd-number field.

As described above, it is the interlace reading-out with the group of four lines being a unit, so that it enables to achieve highly fine interlace moving pictures of smooth movement with high pixels by fast reading-out as well as highly fine still pictures. Thus, the quality of moving images can be remarkably improved.

This effect is achieved by simply applying a little contrivance to the reading-out control unit in regards to the output form of the pixel data, which reads out the pixel data from the photoelectrical conversion element array. Therefore, even though the remarkable improvement is achieved in the moving image quality as described above, complication of the structure can be suppressed so that advantages in terms of product costs can be expected.

This embodiment can also be applied to the simultaneous parallel output through four channels.

### Fourth Embodiment

This embodiment is a modification of the third embodiment, in which, in a unit of four lines as a group, the pixel data of two pixels in the same color are mixed in the vertical direction as in the case of the third embodiment and, at the same time, the pixel data of three pixels are mixed in the horizontal direction. In other words, six pixels are mixed in the horizontal and vertical directions.

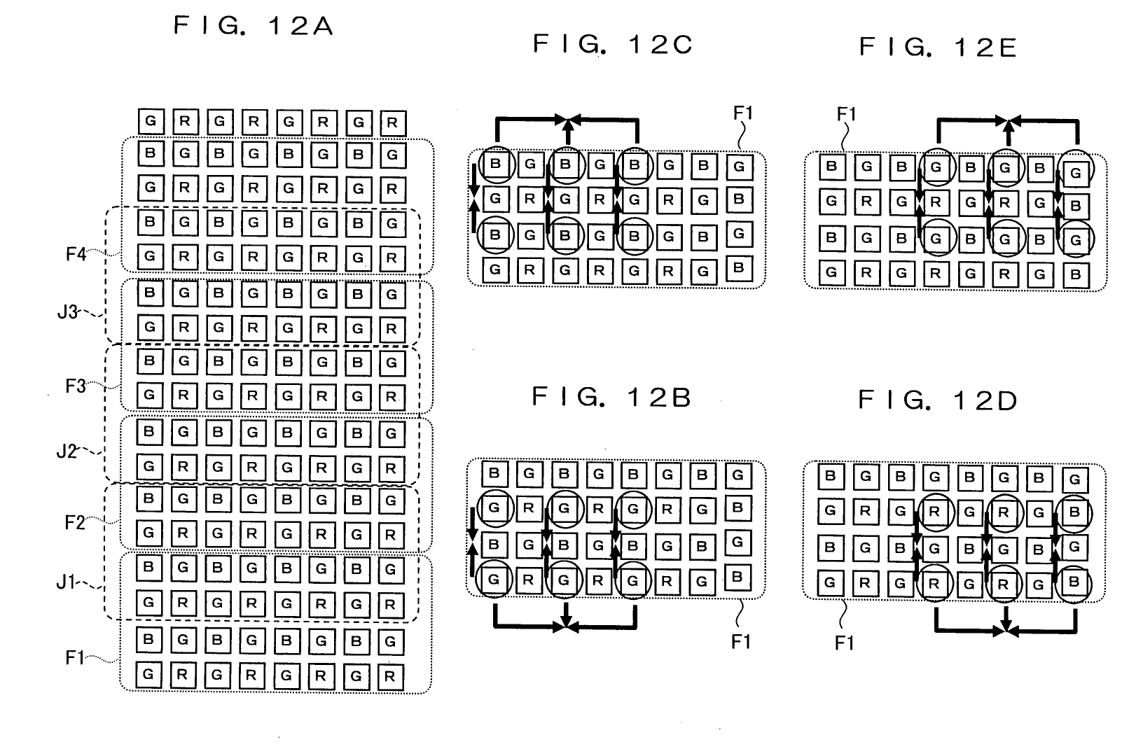

As for the circuit structure, the one used in the third embodiment can be used. FIG. 12B, FIG. 12C, FIG. 12D, FIG. 12E all show the first unit F1. FIG. 12 B and FIG. 12C are at the same moment of time, and FIG. 12D and FIG. 12E are at the same moment of time later than that of FIG. 12B and FIG. 12C.

FIG. 12B shows the state of mixing six pixels of first G (green), and FIG. 12C shows the state of mixing six pixels of B (blue). FIG. 12D shows the state of mixing six pixels of R (red), and FIG. 12E shows the state of mixing six pixels of G (green).

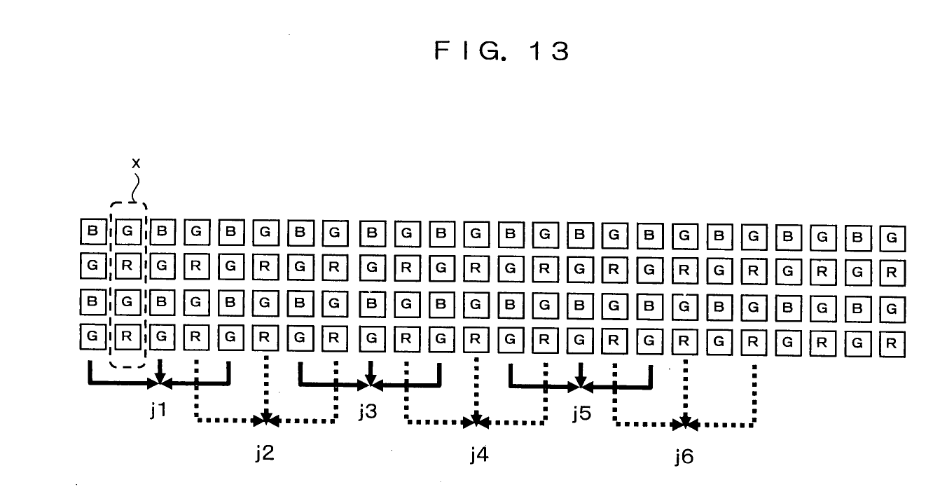

In the horizontal direction, as shown in FIG. 13, it is advanced as in j1→j2→j3→j4→j5→j6 - - - . The 2nd row x is not selected.

Mixing of six pixels is carried out as follows. That is, for example, in the case of mixing six pixels of G (green), in the circuit diagram shown in FIG. 11, the horizontal transfer switches f31, f33, f51, f53 together with the horizontal transfer switches f11, f13 are simultaneously operated (ONN-OFF). Then, for mixing six pixels of R (red), the horizontal transfer switches f61, f63, f81, f83 together with the horizontal transfer switches f41, f43 are simultaneously operated (ONN-OFF).

As described above, it is the interlace reading-out of six-mixed-pixels with the group of four lines being a unit, so that it enables to achieve highly fine interlace moving pictures of smooth movement with high pixels by fast reading-out as well as highly fine still pictures. Thus, the quality of moving images can be remarkably improved.

This effect is achieved by simply applying a little contrivance to the reading-out control unit in regards to the output form of the pixel data, which reads out the pixel data from the photoelectrical conversion element array. Therefore, even though the remarkable improvement is achieved in the moving image quality as described above, complication of the structure can be suppressed so that advantages in terms of product costs can be expected.

This embodiment can also be applied to the simultaneous parallel output through four channels.

As described above, with the present invention, it enables to record high-vision moving pictures or, equivalently, moving pictures with high pixels and high qualities by employing the interlace reading-out.

The solid state image pickup device of the present invention is effectively used as digital cameras and the like having both functions of picking up still pictures and recording moving pictures with high pixels.

The present invention is not limited only to the above-described embodiments but various modifications are possible within the sprit and scope of the appended claims.

1. A solid state image pickup device, comprising:
a photoelectrical conversion element array in matrix form for performing photoelectrical conversion on an optical image entered through an optical system so as to convert it into an electric signal; and
a pixel-data-reading-out control unit having a still-picture-reading-out mode and a moving-picture-reading-out mode for pixel data which is read out from said photoelectrical conversion element array, said pixel-data-reading-out control unit performing interlace reading-out in said moving-picture-reading-out mode by reading out a plurality of adjacent lines as a group of pixel data on whole screen obtained on said photoelectrical conversion element array.

2. The solid state image pickup device according to claim 1, wherein, said pixel-data-reading-out control unit, with n being any natural number, alternately switches:
a first field scanning for performing scanning by a first scanning unit, with pixel data of adjacent 2n lines being a unit on the whole screen obtained on said photoelectrical conversion element array, by shifting 2n lines each; and
a second field scanning for performing scanning by a second scanning unit, with adjacent 2n lines which are shifted by n line from said first scanning unit of said first field scanning being a unit, by shifting 2n lines each.

3. The solid state image pickup device according to claim 1, wherein said pixel-data-reading-out control unit comprises:
a whole-pixel-reading-out mode for picking up still pictures which outputs pixel data read out from said photoelectrical conversion element array in order by each pixel; and mixed-pixel-reading-out mode for recording moving pictures which outputs pixel data by mixing the data of a plurality of pixels at least in vertical direction of said array, wherein
said pixel-data-reading-out control unit alternately switches, with n being any natural number,
a first field scanning for mixing pixel data of 2n+1 lines by skipping one line through performing scanning by a first scanning unit, with pixel data of adjacent said 2n+1 lines being a unit on the whole screen obtained on said photoelectrical conversion element array, by shifting 2n+1 lines each; and
a second field scanning for mixing pixel data of 2n+1 lines by skipping one line through performing scanning by a second scanning unit, with adjacent said 2n+1 lines being shifted by two lines from said first scanning unit of said first field scanning being a unit, by shifting 2n+1 lines each.

4. The solid state image pickup device according to claim 1, wherein said pixel-data-reading-out control unit comprises:
a whole-pixel-reading-out mode for picking up still pictures which outputs pixel data read out from said photoelectrical conversion element array in order by each pixel; and mixed-pixel-reading-out mode for recording moving pictures which outputs pixel data by mixing the data for a plurality of pixels in at least vertical direction of said array, wherein
said pixel-data-reading-out control unit alternately switches, with n being any natural number,
a first field scanning for mixing pixel data of two pairs of 2n lines through performing scanning by a first scanning unit, with pixel data of adjacent 4n lines being a unit on the whole screen obtained on said photoelectrical conversion element array, by shifting 4n lines each; and
a second field scanning for mixing pixel data of two pairs of 2n lines through performing scanning by a second scanning unit, with adjacent said 4n lines which are shifted by 2n lines from said first scanning unit of said first field scanning being a unit, by shifting 4n lines each.

5. The solid state image pickup device according to claim 2, wherein said pixel-data-reading-out control unit further performs horizontal mixing of pixels in each scanning unit as well.

6. The solid state image pickup device according to claim 3, wherein said pixel-data-reading-out control unit further performs horizontal mixing of pixels in each scanning unit as well.

7. The solid state image pickup device according to claim 4, wherein said pixel-data-reading-out control unit further performs horizontal mixing of pixels in each scanning unit as well.

8. The solid state image pickup device according to claim 2, wherein the photoelectrical conversion element array is formed to generate four colors of pixel data as a unit in a group of pixels in two lines and two rows.

9. The solid state image pickup device according to claim 3, wherein the photoelectrical conversion element array is formed to generate four colors of pixel data as a unit in a group of pixels in two lines and two rows.

10. The solid state image pickup device according to claim 4, wherein the photoelectrical conversion element array is formed to generate four colors of pixel data as a unit in a group of pixels in two lines and two rows.

11. The solid state image pickup device according to claim 8, wherein two pixel data out of said four colors of pixel data in said photoelectrical conversion element array are in the same color.

12. The solid state image pickup device according to claim 9, wherein two pixel data out of said four colors of pixel data in said photoelectrical conversion element array are in the same color.

13. The solid state image pickup device according to claim 10, wherein two pixel data out of said four colors of pixel data in said photoelectrical conversion element array are in the same color.

14. The solid state image pickup device according to claim 8, wherein said four colors of pixel data in said photoelectrical conversion element array are pixel data of GRBG (G is green, R is red, B is blue) in Bayer pattern.

15. The solid state image pickup device according to claim 9, wherein said four colors of pixel data in said photoelectrical conversion element array are pixel data of GRBG (G is green, R is red, B is blue) in Bayer pattern.

16. The solid state image pickup device according to claim 10, wherein said four colors of pixel data in said photoelectrical conversion element array are pixel data of GRBG (G is green, R is red, B is blue) in Bayer pattern.

17. The solid state image pickup device according to claim 8, wherein said four colors of pixel data in said photoelectrical conversion element array are complementary-color pixel data of cyanogens, magenta, yellow and green.

18. The solid state image pickup device according to claim 9, wherein said four colors of pixel data in said photoelectrical conversion element array are complementary-color pixel data of cyanogens, magenta, yellow and green.

19. The solid state image pickup device according to claim 10, wherein said four colors of pixel data in said photoelectrical conversion element array are complementary-color pixel data of cyanogens, magenta, yellow and green.

20. The solid state image pickup device according to claim 2, wherein: said photoelectrical conversion element array is formed with a combination of a photodiode, a cell amplifier and a color filter; and said photodiode and said cell amplifier are formed with a MOS transistor.

21. The solid state image pickup device according to claim 3, wherein: said photoelectrical conversion element array is formed with a combination of a photodiode, a cell amplifier and a color filter; and said photodiode and said cell amplifier are formed with a MOS transistor.

22. The solid state image pickup device according to claim 4, wherein: said photoelectrical conversion element array is formed with a combination of a photodiode, a cell amplifier and a color filter; and said photodiode and said cell amplifier are formed with a MOS transistor.

23. The solid state image pickup device according to claim 2, wherein said pixel-data-reading-out control unit comprises:
a vertical transfer switch circuit for reading out pixel data from said photoelectrical conversion element array;
a signal voltage holding circuit for temporarily holding said read-out pixel-data;
a horizontal transfer switch circuit for outputting pixel data or mixed pixel data from said signal voltage holding circuit;
an output amplifier for outputting the pixel data or mixed pixel data transmitted from said horizontal transfer switch circuit; and
a horizontal shift selection circuit for switching output by said whole-pixel-reading-out mode and output by said mixed-pixel-reading-out mode through controlling said horizontal transfer switch circuit.

24. The solid state image pickup device according to claim 3, wherein said pixel-data-reading-out control unit comprises:
a vertical transfer switch circuit for reading out pixel data from said photoelectrical conversion element array;
a signal voltage holding circuit for temporarily holding said read-out pixel-data;
a horizontal transfer switch circuit for outputting pixel data or mixed pixel data from said signal voltage holding circuit;
an output amplifier for outputting the pixel data or mixed pixel data transmitted from said horizontal shift selection circuit; and
a horizontal shift selection circuit for switching output by said whole-pixel-reading-out mode and output by said mixed-pixel-reading-out mode through controlling said horizontal transfer switch circuit.

25. The solid state image pickup device according to claim 4, wherein said pixel-data-reading-out control unit comprises:
a vertical transfer switch circuit for reading out pixel data from said photoelectrical conversion element array;
a signal voltage holding circuit for temporarily holding said read-out pixel-data;
a horizontal transfer switch circuit for outputting pixel data or mixed pixel data from said signal voltage holding circuit;
an output amplifier for outputting the pixel data or mixed pixel data transmitted from said horizontal shift selection circuit; and
a horizontal shift selection circuit for switching output by said whole-pixel-reading-out mode and output by said mixed-pixel-reading-out mode through controlling said horizontal transfer switch circuit.
